(19) United States
(12) Patent Application Publication
(10) Pub. No.: US 2026/0187390 A1
(43) Pub. Date: Jul. 2, 2026

(54) RFID READER WITH AUTONOMOUS MARGIN TESTING AND DEBOUNCE CONTROL

(71) Applicant: Neal J. Lober, Dallas, TX (US)

(72) Inventor: Neal J. Lober, Dallas, TX (US)

(21) Appl. No.: 19/433,568

(22) Filed: Dec. 26, 2025

Related U.S. Application Data
(60) Provisional application No. 63/740,792, filed on Dec. 31, 2024.

(51) Int. Cl. G06K 7/10

(52) U.S. Cl. CPC G06K 7/10356; G06K 7/10227

(57) ABSTRACT

An RFID reader system is disclosed that processes radio frequency signal data received from RFID tags using antenna-level debounce logic, onboard margin testing, and continuous tuning operations. The system obtains tag response data from one or more RFID antennas and applies configurable debounce parameters on a per-antenna basis to suppress redundant tag reads. The system executes margin testing across multiple reader operating parameter states to evaluate tag readability and records performance metrics associated with each configuration state. Tag read data may be filtered during margin testing based on tag selection criteria. The system applies continuous tuning using reference tag data positioned at known locations to detect deviations and generate tuning adjustment parameters. Reader configuration parameters are updated based on the tuning results, and validated tag read events are transmitted to external systems. The reader further includes one or more status indication interfaces configured to present operational state information.

### CROSS-REFERENCE TO RELATED APPLICATIONS

This application claims priority to U.S. Provisional Patent Application No. 63/740,792, entitled “RFID Reader with Autonomous Margin Testing and Debounce Control,” filed on Dec. 31, 2024 the entire disclosure of which is incorporated herein by reference in its entirety.

### BACKGROUND

### Field of the Art

The present disclosure is related to the field of Radio Frequency Identification (RFID) technology, specifically RFID readers.

### Discussion of the State of the Art

Radio-frequency identification (RFID) devices commonly encounter issues pertaining to excessive noise and redundant data due to repeated reads of the same tag. This issue often results in inefficient data management and can render the system impractical for use. Furthermore, RFID readers are frequently subjected to less optimal performance and accuracy in dynamic environments. Variations in tag placement, environmental interference, and system wear can cause readers and their connected antennas to fall out of calibration, leading to inconsistent read performance and potential periods of downtime.

Attempts to resolve the problem of excess noise and redundant data in RFID systems have primarily involved the use of middleware to filter out undesirable reads downstream from the antenna and/or RFID reader. This approach involves complex logic to determine which reads are acceptable based on timing, signal strength, and other factors. However, this solution brings about its own set of problems, including processing overhead, increased operational complexity, latency, increased costs, and the risk of inaccuracies due to misconfigured logic or limitations in the filtering algorithms.

To maintain RFID reader accuracy and performance, current solutions often necessitate manual intervention or the utilization of external software tools to analyze tag readability across various signal strengths. These strategies typically involve running general-purpose margin tests which are orchestrated and conducted by a computer in control of the RFID reader device, collecting raw data for post-processing, and carrying out periodic manual recalibrations. Proper execution of such calibration procedures frequently requires advanced operator training, and inconsistent results are commonly observed both across repeated tuning sessions performed by the same operator and across tuning sessions performed by different operators. However, these solutions are not optimal as they lack granularity, necessitate significant operator involvement, generate large volumes of unfiltered data, and may fail to address calibration drift that occurs between tests, whether scheduled or ad-hoc. This can lead to prolonged periods of suboptimal performance.

### SUMMARY

Systems and methods in accordance with various embodiments of the present disclosure may overcome one or more deficiencies experienced in conventional approaches to Radio Frequency Identification (RFID) reader configuration and signal management. In particular, various embodiments describe systems and methods for processing radio frequency signal data generated by RFID tags, suppressing redundant tag reads, evaluating tag readability across varying signal conditions, and dynamically adjusting reader configuration parameters based on observed operating behavior.

During operation, radio frequency signal data is received from a plurality of RFID antennas associated with one or more RFID readers. The received signal data is processed to identify tag read data (i.e., structured data derived from radio frequency signals received from RFID tags) corresponding to RFID tags detected within respective antenna coverage regions. As tag read data is generated, antenna-level debounce logic is applied to suppress redundant tag reads on a per-antenna basis according to configurable debounce criteria. The resulting tag read data represents a normalized input stream and is often significantly compressed, suitable for subsequent evaluation and configuration management.

The normalized tag read data is evaluated through margin testing operations (i.e., execution of multiple reader configuration variations to evaluate tag readability across differing signal conditions). During margin testing, a sequence of configuration adjustments is applied across multiple reader operating parameters, and tag readability is evaluated for each test configuration. Tag read performance data generated during the margin testing is recorded and analyzed to determine one or more configuration states (i.e., sets of parameter values governing reader operation, including transmit parameters, receive parameters, and tag filtering thresholds). Configuration states may be determined for individual antennas or for logical groupings of antennas operating within shared physical or functional regions.

Continuous tuning is performed by periodically re-evaluating tag read data associated with reference tags (i.e., RFID tags positioned at known locations and used as comparison points during tuning operations). Observed tag read data is compared against reference values or criteria, and configuration states are automatically modified when deviations are detected. Updated configuration parameters are applied to recalibrate reader behavior, and validated tag read events are generated using the recalibrated configuration parameters.

The disclosed techniques are implemented as computer-executed processing pipelines that transform raw radio frequency signal data into validated tag read events through successive stages of filtering, evaluation, configuration selection, and recalibration. The processing pipeline operates on structured data representations, enabling repeatable configuration analysis, adaptive parameter selection, and consistent application of tuning logic.

In certain embodiments, multiple RFID readers operate cooperatively by exchanging tag read data, configuration state information, or tuning results over a network. Such coordination allows processing operations to be distributed across reader devices and enables readers to assist one another in tuning, recalibration, or configuration management. In other embodiments, individual RFID readers operate as standalone systems, executing signal processing, margin testing, and tuning operations locally without reliance on external computing resources.

In various system architectures, portions of the disclosed processing pipeline may be executed at different computational tiers. For example, signal acquisition, debounce processing, and initial evaluation may be performed locally at an RFID reader, while configuration analysis, tuning coordination, or historical performance evaluation may be assisted by edge-based or cloud-based computing systems. The allocation of processing operations across local, edge, or cloud resources may vary based on deployment requirements while preserving the processing flow described herein.

The techniques described herein may be applied across a range of RFID deployments, including warehouse, logistics, retail, manufacturing, asset tracking, and access control environments. RFID readers may be deployed as fixed, semi-fixed, or distributed installations and may operate independently or as part of a coordinated system architecture. Alternative embodiments may vary deployment topology, processing distribution, or coordination mechanisms while maintaining the machine-executed configuration evaluation and tuning operations described above.

Various other functions and advantages are described and suggested below as may be provided in accordance with the various embodiments.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates an example system environment of an RFID reader system, in accordance with various embodiments.

FIG. 2 illustrates an example internal architecture of an RFID reader system, in accordance with various embodiments.

FIG. 3 illustrates an example process for processing radio frequency signal data using an RFID reader system, in accordance with various embodiments.

FIG. 4 illustrates an example process for applying antenna-level debounce logic, in accordance with various embodiments.

FIG. 5 illustrates an example process for performing margin testing across RFID reader operating parameters, in accordance with various embodiments.

FIG. 6 illustrates an example process for filtering tag read data during margin testing, in accordance with various embodiments.

FIG. 7 illustrates an example process for applying continuous tuning using reference tag data, in accordance with various embodiments.

FIG. 8 illustrates an example internal hardware configuration of an RFID reader device, in accordance with various embodiments.

FIG. 9 illustrates an example external interface and indicator configuration of an RFID reader device, in accordance with various embodiments.

FIG. 10 illustrates an example device-level architecture that can support various embodiments.

FIG. 11 illustrates components of a computing device in accordance with various embodiments.

FIG. 12 illustrates an exemplary architecture of a system in accordance with various embodiments.

FIG. 13 illustrates components of a computing device in accordance with various embodiments.

### DETAILED DESCRIPTION

The embodiments described herein relate to systems and methods for machine-executed processing of radio frequency signal data and automated management of RFID reader configuration parameters. The disclosed systems are operable to receive radio frequency signal data from RFID antennas, transform the signal data into structured tag read data, suppress redundant tag reads using antenna-level debounce logic, and evaluate tag readability through margin testing across varying signal conditions. Based on results of the margin testing, the systems determine configuration states defining reader operating parameters and apply continuous tuning logic to automatically recalibrate reader behavior in response to detected variation in operating conditions. These operations may be executed as repeatable computational processes, either on an ad-hoc basis or in accordance with predefined execution conditions, that transform raw signal inputs into validated tag read outputs through successive stages of filtering, evaluation, configuration selection, and recalibration.

In certain embodiments, the disclosed systems and methods operate within warehouse, logistics, retail, or industrial environments in which RFID readers monitor tagged items moving through physical spaces. As RFID tags enter or exit antenna coverage regions, radio frequency signals are captured and processed to generate tag read data. Redundant tag reads are filtered at the antenna level, after which the system evaluates read performance by varying reader operating parameters and observing tag readability under different signal conditions. Based on this evaluation, the system updates reader configuration parameters and applies tuning adjustments over time, allowing the reader to adapt to environmental changes, tag population variability, or physical reconfiguration of the monitored space.

In various embodiments, the disclosed systems and methods may be adapted for use across a range of RFID deployments, including warehouse management, inventory tracking, manufacturing operations, asset monitoring, and access control environments. RFID readers may operate as standalone systems, as coordinated groups of networked readers, or as part of distributed architectures that incorporate edge-based or cloud-assisted processing. Processing responsibilities may be allocated across local reader devices and external computing resources while preserving the machine-executed signal processing, configuration evaluation, and tuning operations described herein. Alternative embodiments may vary deployment topology, processing distribution, or coordination mechanisms without departing from the technical principles disclosed.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Network Architecture

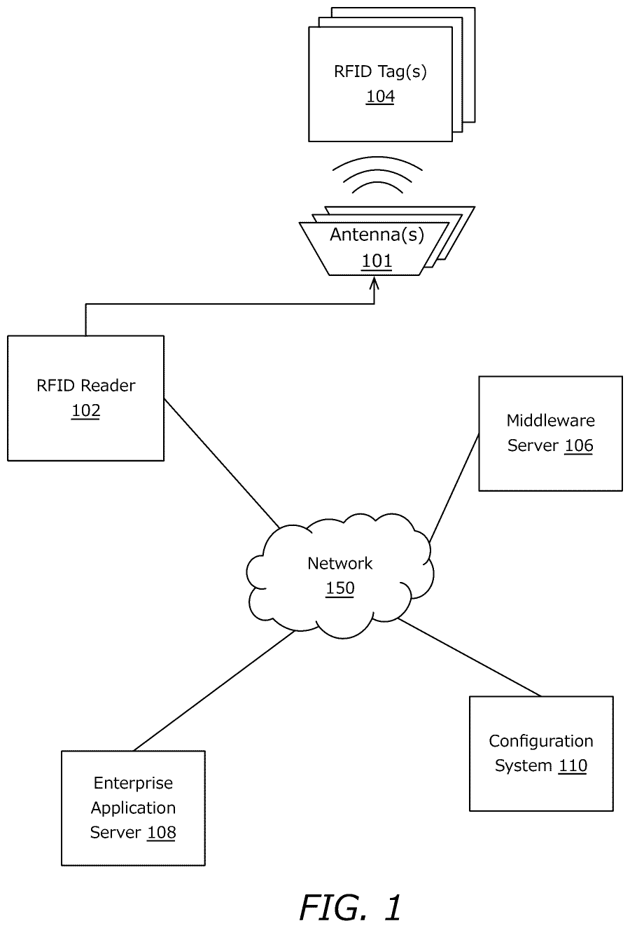

FIG. 1 illustrates an exemplary system environment in which one or more Radio Frequency Identification (RFID) reader systems may operate in accordance with embodiments of the present disclosure. As shown, the environment includes an RFID reader 102 configured to communicate with one or more RFID tags 104 via one or more RFID antenna(s) 101 and to process radio frequency signal data generated in response to tag interrogation. In certain embodiments, the RFID reader 102 may communicate over a network 150 with one or more middleware servers 106, enterprise application server 108, and configuration system 110. The components depicted are exemplary and are provided for purposes of explanation. The illustrated system architecture may be reorganized, combined, omitted, or distributed across multiple computing devices or networked environments without departing from the scope of the present disclosure. Each component may operate independently or cooperatively with other components through wired or wireless communication links, as further described herein.

The system components shown in FIG. 1 are exemplary and may be combined, divided, reorganized, or omitted depending on the deployment architecture. In various embodiments, processing operations described herein may be executed entirely by the RFID reader 102, may be distributed across multiple RFID readers, or may be assisted by one or more external computing systems. The arrangement of components shown in FIG. 1 is not intended to limit the scope of the disclosure, and alternative system configurations capable of performing the disclosed signal processing, configuration evaluation, and tuning operations fall within the scope of the present disclosure.

RFID reader 102 is operable to receive radio frequency signal data from one or more RFID antennas, process the received signal data to identify tag read data associated with detected RFID tags, execute antenna-level debounce logic to suppress redundant tag read events on a per-antenna basis, perform margin testing across multiple reader operating parameters, determine reader configuration states based on margin testing results, apply continuous tuning using reference tags, and generate validated tag read events based on recalibrated configuration parameters. The RFID reader 102 may operate as a standalone device or in communication with one or more remote systems over a network.

More specifically, the RFID reader 102 includes processing circuitry and memory storing executable instructions that cause the reader to ingest raw radio frequency signal data generated in response to interrogation signals transmitted through one or more antennas. The processing circuitry parses the signal data to extract tag identifiers and associated signal characteristics, including timing information, signal strength values, and antenna association metadata. Based on this parsed data, the RFID reader 102 generates structured tag read data entries corresponding to detected RFID tags within respective antenna coverage regions.

The RFID reader 102 executes antenna-level debounce logic by maintaining debounce criteria for each antenna and evaluating temporal relationships between successive tag read data entries associated with the same tag identifier and antenna. When successive tag read data entries satisfy the debounce criteria, the RFID reader 102 suppresses redundant tag read events and prevents propagation of those events into subsequent processing stages. The debounce criteria may be stored as configuration parameters and evaluated independently for each antenna, enabling concurrent and differentiated debounce evaluation across multiple antenna inputs.

In addition to debounce processing, the RFID reader 102 performs margin testing by executing a sequence of configuration adjustments across multiple operating parameters that govern radio frequency interrogation and tag communication behavior. The operating parameters may include transmit power levels, receive sensitivity thresholds, session parameters, antenna port selection, dwell time values, and tag filtering parameters. The operating parameters may further include protocol-level inventory and access control parameters that influence tag population handling and response behavior during interrogation cycles, including parameters that control inventory round timing, anti-collision behavior, tag state transitions, reply persistence, and selection or targeting of subsets of tags within an interrogation field. During margin testing, the RFID reader 102 iteratively applies variations of these operating parameters and evaluates resulting tag read data to characterize tag readability, response stability, and communication reliability across a range of signal and protocol conditions. The RFID reader 102 records tag read performance metrics for each applied configuration state, enabling comparative analysis across test iterations.

Based on the margin testing results, the RFID reader 102 determines one or more reader configuration states, each configuration state defining a set of transmit parameters, receive parameters, and tag filtering thresholds. These configuration states may be determined globally or separately for individual antennas, depending on the evaluated performance characteristics. The RFID reader 102 stores the determined configuration states in memory and applies selected configuration states during subsequent tag reading operations.

The RFID reader 102 further applies continuous tuning by periodically re-evaluating tag read data associated with one or more reference tags positioned at known locations. The reader compares current tag read data associated with the reference tags to stored reference values and evaluates deviations indicative of changes in operating conditions. When deviations are detected, the RFID reader 102 automatically modifies one or more reader configuration states and updates configuration parameters applied to the antennas, thereby recalibrating the reader without manual intervention.

For example, the RFID reader 102 may receive radio frequency signal data from multiple antennas during a scanning interval, extract tag identifiers encoded as binary or hexadecimal values, associate each tag identifier with antenna identifiers and timestamp values, and store the resulting tag read data in a structured record format. The RFID reader 102 may evaluate successive tag read records for a given tag identifier and antenna against a debounce window expressed as a time threshold and suppress records that occur within the debounce window. During margin testing, the RFID reader 102 may vary one or more operating parameters while holding other parameters constant, including varying transmit power in discrete step increments, receive sensitivity thresholds, session parameters, dwell times, or tag filtering criteria. In certain embodiments, the RFID reader 102 repeats margin testing sequences based on a computed selection of alternative operating parameters derived from prior performance metrics, enabling iterative refinement of configuration states across successive test cycles. The RFID reader 102 may record tag detection rates, response stability, or other performance measures for each applied parameter combination and select one or more configuration states corresponding to threshold conditions under which tag readability satisfies predefined evaluation criteria.

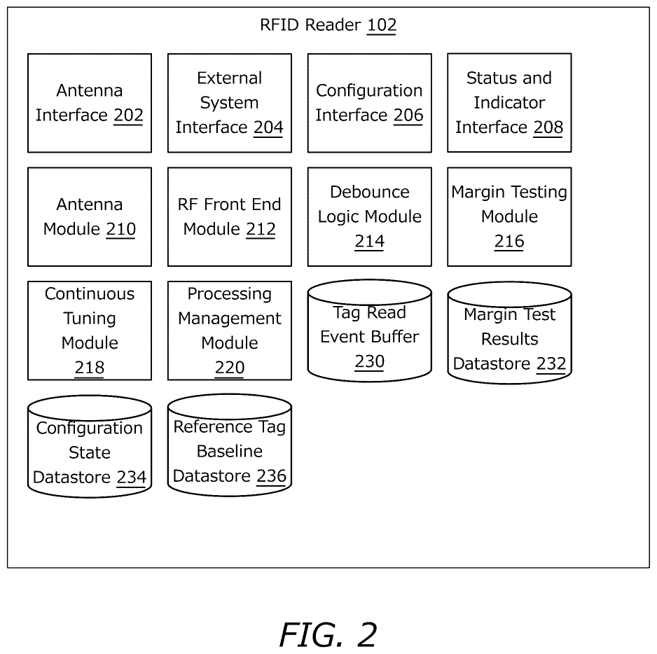

In certain embodiments, the RFID reader 102 communicates validated tag read events and configuration state information to one or more external systems over a wired or wireless network. In other embodiments, the RFID reader 102 performs all debounce processing, margin testing, tuning, and recalibration locally without reliance on external systems. The allocation of processing functions between the RFID reader 102 and remote systems may vary based on deployment architecture, available computational resources, and system configuration, without departing from the scope of the disclosure. RFID reader 102 will be described further in FIG. 2.

RFID antenna(s) 101 are operable to transmit radio frequency interrogation signals generated by RFID reader 102 and to receive radio frequency response signals emitted by RFID tags within an associated coverage region. The RFID antenna(s) 101 are further operable to convey received radio frequency signal data to RFID reader 102 for processing, including tag identification, debounce evaluation, margin testing, configuration state determination, continuous tuning, and recalibration, as described herein.

More specifically, the RFID antenna(s) 101 may include one or more directional or omnidirectional antenna elements configured to operate within one or more RFID frequency bands. Each antenna may be electrically coupled to RFID reader 102 through a corresponding antenna port or communication interface and may be integrated within a housing of RFID reader 102 or positioned remotely and communicatively coupled to RFID reader 102 via a wired or wireless connection. The association between individual antenna elements and received radio frequency signal data is maintained by RFID reader 102, enabling antenna-specific evaluation and control routines to be applied during signal processing.

The RFID antenna(s) 101 operate in coordination with RFID reader 102 to support antenna-level processing by enabling received signal data to be attributed to a specific antenna element. This attribution allows RFID reader 102 to apply independently configurable debounce criteria, margin testing routines, and configuration parameters on a per-antenna basis. The antenna-specific association further enables differentiated evaluation of tag readability across distinct spatial regions and supports determination of antenna-specific configuration states during margin testing and continuous tuning operations.

In certain embodiments, the RFID antenna(s) 101 support multiple operating modes, including sequential activation, concurrent activation, or time-multiplexed activation under control of RFID reader 102. The RFID reader 102 may selectively enable or disable individual antenna elements, adjust transmit parameters associated with each antenna, or modify receive sensitivity thresholds in response to configuration state updates determined through margin testing or continuous tuning. These control operations are executed by RFID reader 102 and applied to the RFID antenna(s) 101 through defined control interfaces.

For example, an RFID reader 102 may cycle through a plurality of RFID antenna(s) 101 during a scanning interval, transmit interrogation signals through each antenna at a specified transmit power level, receive response signals from RFID tags, and associate the resulting signal data with antenna identifiers stored in structured tag read records. During margin testing, RFID reader 102 may adjust transmit power or session parameters for a selected antenna while maintaining constant parameters for other antennas, enabling comparative evaluation of tag readability across antenna coverage regions.

In certain embodiments, the RFID antenna(s) 101 are deployed as part of a distributed reader architecture in which multiple RFID readers and associated antennas communicate over a shared network. In such configurations, RFID antenna(s) 101 may operate under the control of a local RFID reader 102 while participating in coordinated scanning, tuning, or load distribution operations with other RFID readers. The placement, configuration, and operational characteristics of the RFID antenna(s) 101 may vary based on deployment requirements without departing from the scope of the disclosure.

RFID tag(s) 104 are operable to store identifying information and to transmit radio frequency response signals in response to interrogation signals received from RFID reader 102 via one or more RFID antenna(s) 101. The RFID tag(s) 104 are further operable to generate response signals that encode tag identifiers and, in certain embodiments, additional data fields that may be decoded by RFID reader 102 to produce structured tag read data.

More specifically, the RFID tag(s) 104 may comprise passive tags, semi-passive tags, or active tags, each configured to communicate with RFID reader 102 using radio frequency signaling protocols. Passive RFID tag(s) 104 may derive operating power from interrogation signals transmitted by RFID reader 102, while active RFID tag(s) 104 may include an internal power source enabling periodic or event-driven signal transmission. The RFID tag(s) 104 may encode unique identifiers and optional data values within memory elements that are accessed and transmitted in response to interrogation sequences.

The RFID tag(s) 104 interact with RFID reader 102 by receiving interrogation signals transmitted through RFID antenna(s) 101 and emitting corresponding response signals that include encoded tag data. The response signals may be modulated in accordance with RFID communication standards and received by RFID antenna(s) 101, which convey the resulting radio frequency signal data to RFID reader 102. The RFID reader 102 parses the received signal data to extract tag identifiers, signal strength values, timing information, and antenna association metadata used during debounce evaluation, margin testing, and tuning operations.

In certain embodiments, a subset of RFID tag(s) 104 may be deployed as reference tags positioned at known or predetermined locations within a monitored environment. These reference tags are operable to produce consistent response characteristics that may be evaluated by RFID reader 102 during margin testing and continuous tuning. Tag read data associated with the reference tags may be compared against stored reference values to detect variation in operating conditions and to support automated recalibration of reader configuration parameters.

For example, RFID tag(s) 104 may encode tag identifiers formatted as binary or hexadecimal values and may include optional memory banks storing additional data fields. During a scanning interval, RFID reader 102 may receive response signals from multiple RFID tag(s) 104 located within overlapping antenna coverage regions and generate structured tag read records associating each tag identifier with an antenna identifier, timestamp value, and signal strength measurement. Reference tag(s) 104 positioned at known locations may be repeatedly interrogated to generate comparable tag read data used as input to tuning and configuration state determination routines.

In various embodiments, the RFID tag(s) 104 may be attached to objects, assets, or infrastructure elements, embedded within an environment, or deployed in fixed positions for calibration and tuning purposes. The type, placement, and operational characteristics of the RFID tag(s) 104 may vary based on deployment requirements without departing from the scope of the present disclosure.

Middleware server 106 is operable to receive validated tag read events and associated metadata generated by RFID reader 102 and to perform optional aggregation, normalization, buffering, and relay operations to support communication with one or more external systems. The middleware server 106 may operate as an intermediary computing system positioned between RFID reader 102 and other networked components, and may be implemented as a local server, a distributed service, or a cloud-based computing resource.

More specifically, the middleware server 106 may ingest structured tag read data produced by RFID reader 102, including tag identifiers, antenna association information, timestamp values, signal strength measurements, and configuration state indicators. The middleware server 106 may organize the received data into structured records, apply format normalization routines, and manage temporary or persistent storage of tag read events to support asynchronous processing, fault tolerance, or load balancing across multiple consuming systems.

The middleware server 106 may further apply filtering, batching, or routing logic to the received tag read data to facilitate delivery to one or more downstream systems in accordance with defined communication protocols or data schemas. In certain embodiments, the middleware server 106 coordinates data exchange between multiple RFID readers deployed within a shared environment, enabling aggregation of tag read events generated by different readers or antenna groups and supporting coordinated data distribution across the system.

For example, the middleware server 106 may receive validated tag read events encoded in structured data formats such as JSON, XML, or Protocol Buffers and may apply transformation routines to align the data with predefined interface schemas. The middleware server 106 may buffer tag read events during network interruptions, batch multiple events for transmission efficiency, or forward selected subsets of tag read data to one or more enterprise systems or management platforms.

In certain embodiments, the middleware server 106 is optional and is not required for execution of antenna-level debounce logic, margin testing, configuration state determination, continuous tuning, or recalibration operations, which are performed by RFID reader 102 as described herein. In other embodiments, functionality attributed to the middleware server 106 may be distributed across multiple computing devices or integrated into other system components without departing from the scope of the present disclosure.

Enterprise application server 108 is operable to receive structured tag read data and related system state information generated by RFID reader 102, either directly or via middleware server 106, and to execute application-level processing routines that consume the tag read data in accordance with one or more operational workflows. The enterprise application server 108 may host one or more software applications configured to interpret validated tag read events and to integrate the events with other data sources or system processes.

More specifically, the enterprise application server 108 may ingest tag read data formatted as structured records that include tag identifiers, antenna association information, timestamp values, signal metrics, and configuration state indicators. The enterprise application server 108 may process the received data using application-specific logic, including rule evaluation routines, state tracking mechanisms, and event correlation logic, to support system-level monitoring, reporting, or coordination functions. The server may maintain internal data models that map tag read events to logical entities, locations, or system states based on predefined schemas.

The enterprise application server 108 may further coordinate interactions between multiple applications or services that consume RFID-derived data. In certain embodiments, the enterprise application server 108 manages access control, data versioning, or synchronization across multiple application instances, and may expose application programming interfaces (APIs) that enable external systems to retrieve or submit data associated with RFID reader operations.

For example, the enterprise application server 108 may receive validated tag read events transmitted over network 150, store the events in an application datastore, and apply workflow logic that evaluates event sequences over time. The server may generate structured outputs reflecting application-specific interpretations of the tag read data and may communicate such outputs to other systems or interfaces in accordance with defined protocols.

In various embodiments, the enterprise application server 108 may be implemented as a centralized server, a distributed application platform, or a cloud-hosted service. In other embodiments, functionality attributed to the enterprise application server 108 may be partitioned across multiple computing environments or omitted entirely, with RFID reader 102 operating independently to generate validated tag read events without reliance on enterprise-level application processing.

Configuration system 110 is operable to exchange configuration information with RFID reader 102 and to support coordination, monitoring, and propagation of reader configuration parameters across one or more RFID reader systems. The configuration system 110 may operate as a local or remote computing system and may communicate with RFID reader 102 over network 150 to receive status information and to provide configuration inputs, without displacing machine-executed tuning and recalibration operations performed by the RFID reader 102.

More specifically, the configuration system 110 may maintain configuration data structures defining parameter values associated with reader operation, including debounce criteria, margin testing parameters, tuning intervals, antenna-specific settings, and operational thresholds. The configuration system 110 may transmit configuration parameters to RFID reader 102 for storage and execution, and may receive configuration state information, status indicators, or diagnostic metadata generated by RFID reader 102 during operation. The configuration system 110 may further track versioned configuration profiles and manage parameter updates across multiple RFID reader deployments.

The configuration system 110 may support coordination among multiple RFID reader systems by distributing configuration parameters, aggregating configuration state information, or facilitating synchronized configuration updates. In certain embodiments, the configuration system 110 enables propagation of parameter changes to multiple RFID readers operating within a shared environment, while each RFID reader independently executes debounce logic, margin testing, configuration state determination, continuous tuning, and recalibration based on locally executed instructions.

For example, the configuration system 110 may store debounce window values, margin testing schedules, or reference tag identifiers in structured configuration records and transmit the records to one or more RFID readers using a defined communication protocol. The configuration system 110 may receive status information indicating active configuration states, tuning activity, or detected deviations associated with reference tags and may record such information for monitoring or coordination purposes.

In various embodiments, the configuration system 110 may provide interfaces for initiating configuration exchanges, retrieving configuration state information, or managing deployment-wide parameter sets. In other embodiments, functionality attributed to the configuration system 110 may be implemented within other system components or distributed across multiple computing environments, and RFID reader 102 may operate autonomously using locally stored configuration parameters without reliance on an external configuration system.

Network 150 is operable to provide a communication infrastructure that enables data exchange among RFID reader 102, RFID antenna(s) 101, RFID tag(s) 104, middleware server 106, enterprise application server 108, and configuration system 110. The network 150 facilitates transmission of radio frequency—derived data, configuration information, status indicators, and control messages among the various system components in accordance with the communication requirements of a given deployment.

More specifically, the network 150 may comprise one or more wired or wireless communication networks, including local area networks, wide area networks, mesh networks, cellular networks, or combinations thereof. Communication links supported by the network 150 may utilize Ethernet, Wi-Fi, Bluetooth, cellular, optical, or other suitable communication technologies. The network 150 may support direct or indirect communication paths between components, and data exchange may occur synchronously or asynchronously depending on system configuration.

The network 150 enables RFID reader 102 to communicate validated tag read events, configuration state information, and status data to external systems, and enables receipt of configuration parameters or coordination messages from configuration system 110 or other networked components. In distributed deployments, the network 150 may further support communication among multiple RFID reader systems to facilitate coordinated operation, load distribution, or shared monitoring functions.

For example, the network 150 may convey structured tag read data encoded in standardized message formats between RFID reader 102 and middleware server 106, transmit configuration updates from configuration system 110 to multiple RFID readers, or support communication between RFID reader systems deployed at different physical locations. The specific topology, protocols, and communication technologies employed by the network 150 may vary based on deployment requirements without departing from the scope of the present disclosure.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

### RFID Reader

FIG. 2 illustrates an exemplary embodiment of the internal components of RFID reader 102 in accordance with one embodiment of the present disclosure. Reference numbers are carried over between figures for similar components for consistency of explanation, without limiting the scope of any particular embodiment unless expressly stated. As shown, RFID reader 102 includes antenna interface 202, external system interface 204, configuration interface 206, status and indicator interface 208, antenna module 210, RF front-end module 212, debounce logic module 214, margin testing module 216, continuous tuning module 218, processing and management module 220, tag read event buffer 230, margin test results datastore 232, configuration state datastore 234, and reference tag baseline datastore 236. The components depicted are exemplary and may be reorganized, combined, omitted, or distributed across hardware, firmware, or software execution contexts as would be apparent to a person of ordinary skill in the art.

The RFID reader 102 may further include additional interfaces, processing routines, control logic, or memory structures not explicitly illustrated in FIG. 2 but readily implementable by a person of ordinary skill in the art. For example, the RFID reader 102 may incorporate auxiliary protocol handlers for additional RFID standards, supplemental signal conditioning routines, or additional datastore structures for maintaining historical tuning data, configuration versioning records, or diagnostic execution logs. Other processing workflows, memory structures, and interface layers may be added, omitted, or distributed across local or networked computing resources as appropriate to support antenna-level debounce processing, margin testing, configuration state determination, continuous tuning, and recalibration operations executed by RFID reader 102.

Antenna interface 202 is operable to electrically and logically couple RFID reader 102 to one or more RFID antenna(s) 101 and to convey radio frequency signal data and control signals between the antenna(s) and internal signal processing components of the RFID reader. The antenna interface 202 enables attribution of received signal data to specific antenna elements and supports antenna-specific execution of debounce, margin testing, and tuning operations. More specifically, the antenna interface 202 receives radio frequency response signals captured by RFID antenna(s) 101 and converts the signals into signal data suitable for processing by RF front-end module 212. The antenna interface 202 further conveys antenna identification metadata, timing information, and signal routing information that allows subsequent processing stages to associate tag read data with a corresponding antenna coverage region. Control signals generated by processing and management module 220 may also be transmitted through antenna interface 202 to enable selective activation, deactivation, or parameter adjustment for individual antenna elements.

In certain embodiments, antenna interface 202 supports multiple antenna connection modalities, including direct physical coupling, multiplexed antenna switching, or remote antenna connectivity via wired or wireless links. The antenna interface 202 may maintain antenna mapping tables or port association structures stored in memory to preserve deterministic routing between antenna elements and internal processing paths.

For example, antenna interface 202 may receive response signals from multiple antenna ports during a scanning cycle, tag each signal stream with a corresponding antenna identifier, and forward the signal data to RF front-end module 212 while preserving antenna-level attribution used during debounce evaluation and configuration state determination.

External system interface 204 is operable to facilitate bidirectional data exchange between RFID reader 102 and one or more external systems, including middleware server 106, enterprise application server 108, and other networked computing resources. The external system interface 204 enables transmission of validated tag read events, configuration state information, and operational status metadata generated by RFID reader 102, and supports receipt of control messages, configuration updates, or coordination signals from external systems without displacing machine-executed processing performed within the RFID reader.

More specifically, the external system interface 204 implements communication logic for packaging internally generated data into structured message formats and transmitting the messages over network 150 using one or more supported communication protocols. The interface 204 may encode tag read events as structured records comprising tag identifiers, antenna association data, timestamp values, signal metrics, and configuration state identifiers. Incoming messages received via the external system interface 204 may be parsed to extract configuration parameters, execution triggers, or synchronization indicators that are routed to processing and management module 220 or stored in configuration state datastore 234 for subsequent execution by RFID reader 102.

The external system interface 204 supports asynchronous and event-driven communication patterns, allowing RFID reader 102 to operate autonomously while selectively exchanging data with external systems. In certain embodiments, the interface 204 manages buffering, acknowledgement handling, retry logic, or message sequencing to ensure reliable data transfer under variable network conditions. The external system interface 204 may further enforce schema conformity or version compatibility when exchanging structured data with heterogeneous external systems.

For example, the external system interface 204 may transmit validated tag read events encoded in JSON or Protocol Buffers format to middleware server 106 for aggregation or relay, while concurrently receiving configuration update messages specifying revised debounce criteria or margin testing schedules. The interface 204 may route received configuration updates to configuration interface 206 for storage and application by RFID reader 102 during subsequent processing cycles.

In various embodiments, the external system interface 204 may be implemented using wired or wireless communication technologies and may support secure communication mechanisms, including authentication, encryption, or access control routines. The scope and function of the external system interface 204 may vary based on deployment architecture, and in certain configurations RFID reader 102 may operate independently with limited or no interaction with external systems without departing from the scope of the present disclosure.

Configuration interface 206 is operable to receive, store, and propagate configuration parameters associated with operation of RFID reader 102, including parameters governing antenna-level debounce logic, margin testing execution, configuration state selection, and continuous tuning behavior. The configuration interface 206 enables coordinated configuration exchange between RFID reader 102 and external systems while preserving execution of configuration-dependent processing within the RFID reader.

More specifically, the configuration interface 206 parses incoming configuration data received from external system interface 204 or other internal sources and maps the configuration data to structured configuration records maintained by RFID reader 102. The configuration records may include debounce criteria defined on a per-antenna basis, margin testing parameters defining operating parameter ranges and test sequencing, tuning schedules, reference tag identifiers, and thresholds used to evaluate variation in operating conditions. The configuration interface 206 routes the parsed configuration data to processing and management module 220 and stores applicable parameter values in configuration state datastore 234 for use during machine-executed processing.

The configuration interface 206 further supports versioned configuration management by associating configuration parameters with configuration identifiers or revision metadata. This enables RFID reader 102 to apply configuration updates deterministically and to maintain consistency between configuration states evaluated during margin testing and configuration states applied during normal tag reading operations. In certain embodiments, the configuration interface 206 supports staged or conditional application of configuration updates, allowing new parameter values to be evaluated during margin testing prior to full application across all antennas. For example, the configuration interface 206 may receive a configuration message specifying updated debounce window values for a subset of antennas and revised margin testing parameters defining transmit power step increments and dwell time values. The configuration interface 206 may store the received parameters as a new configuration state entry in configuration state datastore 234 and notify processing and management module 220 of the availability of the updated configuration state for evaluation during subsequent margin testing cycles.

In various embodiments, the configuration interface 206 may also provide outbound communication of configuration state information generated by RFID reader 102, including active configuration identifiers, tuning activity indicators, or detected deviations associated with reference tags. Such outbound configuration state information may be transmitted to external systems for coordination or monitoring purposes without altering execution of debounce, margin testing, tuning, or recalibration operations performed by RFID reader 102.

Status and indicator interface 208 is operable to generate and apply control signals that cause one or more status indicators associated with RFID reader 102 to present state information produced by machine-executed operations of the RFID reader. The status and indicator interface 208 enables indication of operational states associated with tag reading, antenna-level debounce processing, margin testing execution, continuous tuning activity, configuration state transitions, and detected operating condition variation.

More specifically, the status and indicator interface 208 receives status inputs and state transition signals from processing and management module 220 and maps the received inputs to indicator control outputs. The indicator control outputs may include control values corresponding to illumination states, color selections, pattern selections, display strings, icon identifiers, or other indicator encodings supported by the particular indicator hardware integrated with RFID reader 102. The status and indicator interface 208 may maintain an internal mapping table that associates defined operational states with corresponding indicator output encodings, enabling deterministic and repeatable presentation of state information.

The status and indicator interface 208 may further support concurrent state reporting by prioritizing indicator outputs when multiple operational states are active. In certain embodiments, the status and indicator interface 208 implements a state arbitration routine that assigns precedence to defined conditions, including error conditions, margin testing execution states, tuning or recalibration states, and nominal operating states. The status and indicator interface 208 may also implement timed pattern scheduling logic to maintain an indicator pattern for a defined time interval, to pulse an indicator pattern during an active processing interval, or to switch indicator outputs upon completion of a processing sequence.

For example, when RFID reader 102 initiates a margin testing sequence, processing and management module 220 may assert a margin testing state flag and provide a test iteration identifier. The status and indicator interface 208 may map the asserted state to a predefined indicator pattern and apply control signals that cause an indicator to display a corresponding pattern during the margin testing interval. When continuous tuning detects deviation associated with a reference tag and triggers a configuration state update, the status and indicator interface 208 may apply a different indicator encoding corresponding to a tuning or recalibration state and then transition back to a nominal operating state upon completion of the update.

In various embodiments, the status and indicator interface 208 communicates with indicator hardware through one or more communication buses or control interfaces and may generate control signals compatible with discrete output drivers, serial peripheral interfaces, general-purpose input/output lines, or display controller interfaces. The specific indicator hardware and supported indicator encodings may vary by device configuration without departing from the scope of the present disclosure.

Antenna module 210 is operable to manage logical representation, configuration, and operational control of one or more RFID antenna(s) associated with RFID reader 102. The antenna module 210 maintains antenna-specific state information and coordinates antenna participation in tag reading operations, debounce evaluation, margin testing execution, configuration state application, and continuous tuning routines executed by the RFID reader.

More specifically, the antenna module 210 maintains antenna configuration records that associate individual antenna identifiers with operational parameters, including debounce criteria, transmit parameter assignments, receive parameter thresholds, and configuration state identifiers. These antenna configuration records enable RFID reader 102 to apply differentiated processing logic on a per-antenna basis, including independent debounce evaluation and antenna-specific configuration state selection determined through margin testing and tuning operations.

The antenna module 210 further manages antenna activation sequencing and participation control during scanning, testing, and tuning operations. In certain embodiments, the antenna module 210 coordinates with processing and management module 220 to selectively enable or disable individual antennas, to assign antennas to specific margin testing iterations, or to exclude antennas from particular processing cycles based on configuration state information or detected operating conditions. Antenna participation decisions are executed by machine-executed control routines and may be updated dynamically as configuration states are modified.

For example, during a margin testing sequence, the antenna module 210 may designate a subset of antennas for evaluation under varying transmit power levels while maintaining other antennas in a nominal operating configuration. The antenna module 210 may update antenna configuration records stored in configuration state datastore 234 to reflect test-specific parameter assignments and may restore antenna configurations upon completion of the margin testing sequence.

In certain embodiments, the antenna module 210 supports reallocation of antenna roles in distributed deployments involving multiple RFID readers. Antenna configuration records may be updated to reflect changes in antenna coverage regions, reference tag association, or tuning participation based on coordination signals received through external system interface 204. The antenna module 210 may also associate specific antennas with reference tag identifiers stored in reference tag baseline datastore 236 to support antenna-specific tuning and recalibration.

In various embodiments, the antenna module 210 operates independently of physical antenna placement and may manage antennas that are integrated within RFID reader 102 or remotely coupled via wired or wireless connections. The internal data structures and control logic maintained by the antenna module 210 may vary based on deployment architecture while preserving per-antenna execution of debounce, margin testing, and tuning operations as described herein.

RF front-end module 212 is operable to generate, condition, and process radio frequency signals exchanged between RFID reader 102 and RFID antenna(s) 101. The RF front-end module 212 performs machine-executed signal generation and signal conditioning operations that convert raw radio frequency responses into signal data suitable for subsequent tag identification, debounce evaluation, margin testing, and tuning operations executed by RFID reader 102.

More specifically, the RF front-end module 212 includes signal generation logic for producing interrogation signals transmitted through antenna interface 202 and signal reception logic for capturing response signals received from RFID tag(s) 104. The RF front-end module 212 applies signal conditioning routines to received signals, including amplification, filtering, demodulation, and analog-to-digital conversion, to generate digital signal representations that preserve timing, amplitude, and frequency characteristics associated with each received response. These digital signal representations are forwarded to processing and management module 220 with associated antenna identification metadata.

The RF front-end module 212 further supports dynamic adjustment of transmit and receive parameters under control of configuration state information determined through margin testing and continuous tuning operations. Transmit parameters may include power level settings, modulation characteristics, or session parameters, while receive parameters may include sensitivity thresholds, gain values, or filtering coefficients. Parameter adjustments are applied by the RF front-end module 212 in accordance with configuration states selected by processing and management module 220 and stored in configuration state datastore 234.

For example, during execution of a margin testing sequence, the RF front-end module 212 may iteratively adjust transmit power levels in defined step increments while maintaining constant receive sensitivity, or may adjust receive sensitivity thresholds while holding transmit parameters constant. The RF front-end module 212 applies each parameter variation to subsequent interrogation cycles and generates corresponding digital signal data that is evaluated by RFID reader 102 to characterize tag readability across varying signal conditions.

In certain embodiments, the RF front-end module 212 supports concurrent or time-multiplexed operation across multiple antennas by coordinating signal generation and reception sequences with antenna interface 202. The RF front-end module 212 may serialize or parallelize interrogation cycles based on antenna participation assignments determined by antenna module 210, enabling controlled evaluation of antenna-specific performance during scanning and testing operations.

In various embodiments, the RF front-end module 212 may be implemented using discrete RF circuitry, integrated RF transceiver components, or programmable signal processing hardware, and may execute control routines in firmware or software. The specific signal processing techniques and hardware configurations employed by the RF front-end module 212 may vary based on frequency band, protocol support, or deployment requirements without departing from the scope of the present disclosure.

Debounce logic module 214 is operable to execute antenna-level debounce processing on tag read data generated by RFID reader 102 in order to suppress redundant tag read events on a per-antenna basis. The debounce logic module 214 applies machine-executed temporal evaluation logic to tag read data associated with individual RFID antennas and generates filtered tag read events for subsequent margin testing, tuning, configuration state determination, and validation operations.

More specifically, the debounce logic module 214 receives structured tag read data from processing and management module 220, the tag read data including tag identifiers, antenna identifiers, and timestamp values derived from radio frequency signal data processed by RF front-end module 212. The debounce logic module 214 maintains antenna-specific debounce criteria that define one or more debounce windows, thresholds, or timing constraints used to evaluate successive tag read events associated with a given tag identifier and antenna. The debounce criteria may be stored as part of antenna configuration records or configuration state entries maintained in configuration state datastore 234.

The debounce logic module 214 evaluates successive tag read events by comparing timestamp values associated with a current tag read event to timestamp values associated with one or more prior tag read events for the same tag identifier and antenna. When the evaluated temporal difference satisfies the debounce criteria, the debounce logic module 214 suppresses the current tag read event and prevents propagation of the event to subsequent processing stages. When the evaluated temporal difference exceeds the debounce criteria, the debounce logic module 214 permits generation of a validated tag read event and updates internal tracking records to reflect the newly accepted event.

The debounce logic module 214 further supports independent configuration of debounce criteria for different antennas, enabling differentiated debounce behavior across multiple antenna coverage regions. In certain embodiments, debounce criteria may be adjusted dynamically based on configuration state updates determined through margin testing or continuous tuning operations. The debounce logic module 214 applies updated debounce criteria deterministically upon activation of a corresponding configuration state without requiring manual intervention.

For example, the debounce logic module 214 may maintain a data structure associating each antenna identifier with a debounce window expressed as a time interval. During operation, the module may receive successive tag read events for a given tag identifier detected by the same antenna within the defined debounce window and suppress the redundant events. When the same tag identifier is detected outside the debounce window, the debounce logic module 214 may generate a validated tag read event and record the associated timestamp value for subsequent debounce evaluations.

In certain embodiments, the debounce logic module 214 executes concurrently across multiple antennas by maintaining separate debounce evaluation contexts for each antenna identifier. In other embodiments, the debounce logic module 214 applies debounce evaluation at a logical grouping level that aggregates tag read events from two or more physical antennas associated with a common logical zone, coverage region, or reader-defined grouping. In such embodiments, tag read events received from multiple antennas assigned to the same logical grouping are evaluated against a shared debounce window to suppress redundant tag read events across the grouped antennas. The debounce logic module 214 may track prior tag read events using in-memory caches, rolling timestamp buffers, indexed lookup structures, or other data structures optimized for high-frequency tag read evaluation. The specific grouping strategy, data structures, and evaluation routines employed by the debounce logic module 214 may vary based on deployment requirements while preserving deterministic debounce execution independent of margin testing or tuning operations.

In certain embodiments, the debounce logic module 214 operates independently of margin testing or continuous tuning operations. In such embodiments, antenna-level or logically grouped debounce parameters are configured and applied to suppress redundant tag read events without performing margin testing or adjusting reader operating parameters based on tuning results. These embodiments enable deterministic suppression of redundant tag reads in deployments where reader configuration parameters are fixed, externally managed, or otherwise not subject to dynamic tuning.

Margin testing module 216 is operable to execute machine-executed margin testing operations that evaluate tag readability across a range of RFID reader operating parameters and to generate performance data used to determine reader configuration states. The margin testing module 216 applies controlled parameter variation logic to interrogation and reception cycles executed by RFID reader 102 and produces structured margin test results that characterize tag read behavior under differing signal conditions.

More specifically, the margin testing module 216 coordinates execution of margin testing sequences by selecting one or more operating parameters to vary across a defined set of test iterations. The operating parameters may include transmit power levels, receive sensitivity thresholds, session parameters, antenna port selection, dwell time values, step increment values, and tag filtering parameters. For each test iteration, the margin testing module 216 causes RF front-end module 212 to apply a specific parameter configuration while antenna module 210 controls antenna participation, and debounce logic module 214 continues to suppress redundant tag read events during test execution.

The margin testing module 216 collects tag read data generated during each test iteration and associates the tag read data with corresponding parameter values, antenna identifiers, and iteration identifiers. The collected data is stored as structured margin test records in margin test results datastore 232. Each margin test record may include tag identifiers, signal strength measurements, read success indicators, timestamp values, and configuration state references, enabling deterministic analysis of tag readability across the tested parameter space.

The margin testing module 216 further supports selective evaluation of tag read data through execution of tag filtering routines during margin testing intervals. In certain embodiments, the module applies tag filtering criteria to focus analysis on a subset of tag identifiers, antenna coverage regions, or reference tags. The filtering criteria may be specified as part of configuration parameters received through configuration interface 206 and may be adjusted between test iterations. By constraining the evaluated data set, the margin testing module 216 enables controlled analysis of tag performance in environments containing multiple concurrently detectable tags.

The margin testing module 216 executes analysis routines that evaluate the collected margin test records to identify parameter thresholds or transition points at which tag readability changes. The analysis routines may compute metrics such as read success rates, signal margin values, or stability indicators across test iterations. Based on the evaluated metrics, the margin testing module 216 generates intermediate evaluation outputs that are provided to processing and management module 220 for determination of one or more reader configuration states.

For example, the margin testing module 216 may execute a test sequence in which transmit power is varied in discrete step increments across a defined range while one or more other interrogation parameters are held constant. For each applied power level, the module records whether a given tag identifier is successfully read by a selected antenna and associates the read outcome with the applied configuration state. In addition to binary read success, the margin testing module 216 may evaluate qualitative characteristics of the returned signal, including received signal strength indicators (RSSI), phase or timing stability, modulation or backscatter quality metrics, error indicators, or read consistency across multiple interrogation cycles. The resulting margin test records may identify threshold or transition points at which tag readability changes based on one or more quantitative or qualitative signal criteria, enabling subsequent selection of transmit parameters, receive sensitivity thresholds, or other interrogation settings for a reader configuration state.

In certain embodiments, the margin testing module 216 may be triggered based on scheduled execution, detection of operating condition variation, or activation by processing and management module 220. The margin testing module 216 operates without reliance on external testing tools and executes entirely within RFID reader 102, while optionally exchanging status information or test results with external systems through external system interface 204. The scope and granularity of margin testing sequences may vary based on deployment requirements while preserving machine-executed evaluation of tag readability across configurable signal conditions as described herein.

In certain embodiments, margin testing module 216 and continuous tuning module 218 operate independently of the debounce logic module 214. In such embodiments, the RFID reader evaluates tag readability across varying operating parameters and applies tuning adjustments based on margin testing results or reference tag deviations without applying antenna-level debounce suppression. These embodiments enable optimization of reader configuration parameters in environments where downstream systems handle tag read consolidation or where redundant read suppression is not required at the reader level.

Continuous tuning module 218 is operable to perform machine-executed continuous tuning and recalibration of RFID reader 102 based on evaluation of tag read data associated with reference tags independent of margin testing execution and previously determined configuration states. The continuous tuning module 218 applies automated evaluation logic to detect variation in operating conditions and to modify reader configuration states to maintain consistent tag read behavior across time and environmental changes.

More specifically, the continuous tuning module 218 monitors tag read data generated during normal operation and selectively evaluates tag read data associated with one or more reference tags positioned at known locations. The reference tags serve as stable comparison points for assessing variation in signal conditions, antenna performance, or reader configuration effectiveness. The continuous tuning module 218 retrieves reference baseline values associated with the reference tags from reference tag baseline datastore 236 and compares current tag read data to the stored baseline values using deterministic evaluation routines.

The continuous tuning module 218 detects deviations between current tag read data and corresponding baseline values by evaluating differences in signal metrics, read success indicators, or timing characteristics. When a deviation satisfies one or more tuning criteria, the continuous tuning module 218 initiates modification of one or more reader configuration states. The modified configuration states may adjust transmit parameters, receive parameters, debounce criteria, or tag filtering thresholds associated with one or more antennas, and are stored in configuration state datastore 234 for subsequent application.

The continuous tuning module 218 operates in coordination with processing and management module 220 to apply updated configuration states to RFID reader 102. Upon activation of a modified configuration state, RF front-end module 212 applies updated signal parameters, antenna module 210 updates antenna-specific configuration records, and debounce logic module 214 applies updated debounce criteria as applicable. The continuous tuning module 218 thereby enables recalibration of RFID reader 102 without manual intervention and without interrupting ongoing tag reading operations.

For example, the continuous tuning module 218 may periodically evaluate signal strength measurements associated with a reference tag detected by a specific antenna and compare the measurements to baseline signal strength values stored in reference tag baseline datastore 236. If the measured signal strength deviates beyond a defined threshold, the continuous tuning module 218 may initiate selection of an alternative configuration state that increases transmit power or adjusts receive sensitivity for the affected antenna. The updated configuration state may then be applied during subsequent interrogation cycles.

In certain embodiments, the continuous tuning module 218 executes tuning evaluations at scheduled intervals, in response to detected anomalies in tag read performance, or upon completion of margin testing sequences. The tuning logic may be executed independently for different antennas or antenna groups, enabling localized recalibration within a multi-antenna deployment. The specific evaluation criteria, thresholds, and configuration modification routines employed by the continuous tuning module 218 may vary based on deployment requirements while preserving automated, machine-executed recalibration as described herein.

In an embodiment, the continuous tuning module 218 operates independently of the margin testing module 216. In such embodiments, the continuous tuning module 218 performs evaluation of reference tag data and modification of reader configuration states during normal reader operation without executing margin testing sequences or varying operating parameters across predefined test ranges. Continuous tuning may thus be performed based solely on comparison of current tag read data to stored reference baseline values, enabling ongoing recalibration without invoking margin testing workflows.

In certain embodiments, the debounce logic module 214 operates in conjunction with the margin testing module 216 and the continuous tuning module 218. In such embodiments, debounce processing is applied to tag read data prior to, during, or after margin testing and tuning operations to reduce redundant tag read events while reader configuration parameters are iteratively evaluated and adjusted. The debounce, margin testing, and tuning operations may execute sequentially, concurrently, or conditionally based on system configuration, without requiring that any single operation be dependent on execution of another.

Processing and management module 220 is operable to coordinate execution of machine-executed operations performed by RFID reader 102 and to manage control flow, data routing, and configuration state application across internal interfaces, functional modules, and datastores. The processing and management module 220 serves as an execution orchestration component that sequences antenna-level debounce processing, margin testing operations, configuration state determination, continuous tuning, and recalibration without reliance on manual control.

More specifically, the processing and management module 220 receives processed signal data and tag read data from RF front-end module 212 and antenna interface 202, and routes the data to debounce logic module 214 for antenna-level filtering. Validated tag read events generated by debounce logic module 214 are selectively forwarded to margin testing module 216, continuous tuning module 218, or external system interface 204 based on active execution context and configuration state. The processing and management module 220 maintains execution state indicators that reflect whether the RFID reader is operating in a normal scanning mode, a margin testing mode, or a tuning and recalibration mode.

The processing and management module 220 further manages activation and application of configuration states determined through margin testing and tuning operations. Configuration state identifiers generated by margin testing module 216 or modified by continuous tuning module 218 are retrieved from configuration state datastore 234 and applied by issuing control signals to RF front-end module 212, antenna module 210, and debounce logic module 214. The processing and management module 220 ensures that configuration state transitions occur deterministically and that parameter updates are applied in a coordinated manner across affected components.

The processing and management module 220 also manages data persistence and retrieval operations involving internal datastores. Tag read events generated during scanning or testing operations may be temporarily stored in tag read event buffer 230, margin testing results may be stored in margin test results datastore 232, configuration states may be stored and versioned within configuration state datastore 234, and reference tag baseline values may be retrieved from reference tag baseline datastore 236. The processing and management module 220 coordinates access to these datastores and enforces consistency between stored data and active execution contexts.

For example, upon detection of a deviation associated with a reference tag by continuous tuning module 218, the processing and management module 220 may retrieve a modified configuration state from configuration state datastore 234, instruct RF front-end module 212 to apply updated transmit and receive parameters, update antenna-specific records maintained by antenna module 210, and signal debounce logic module 214 to apply revised debounce criteria. The processing and management module 220 may also notify status and indicator interface 208 of the configuration transition and transmit updated configuration state information to external systems via external system interface 204.

In certain embodiments, the processing and management module 220 executes scheduling and trigger evaluation routines that determine when margin testing or tuning operations are initiated. Such triggers may be based on predefined schedules, detected variation in tag read performance, completion of prior execution sequences, or receipt of coordination signals via configuration interface 206. The specific control logic and execution sequencing implemented by processing and management module 220 may vary based on deployment requirements while preserving coordinated, machine-executed operation of RFID reader 102 as described herein.

Tag read event buffer 230 is operable to temporarily store structured tag read events generated by RFID reader 102 during scanning, margin testing, and tuning operations. The tag read event buffer 230 maintains tag read records that include tag identifiers, antenna identifiers, timestamp values, signal metrics, and configuration state references, enabling deterministic access to recent tag read activity during machine-executed processing. The tag read event buffer 230 supports controlled buffering and retrieval of tag read events to accommodate asynchronous processing, burst traffic conditions, or sequencing requirements enforced by processing and management module 220. More specifically, the tag read event buffer 230 may be implemented as a circular buffer, queue structure, or indexed memory region that stores tag read events in temporal order. The processing and management module 220 may retrieve tag read events from the buffer to support debounce evaluation, margin testing analysis, or tuning-related comparisons without requiring repeated interrogation of RFID tags. Buffer management routines may enforce size limits, eviction policies, or prioritization rules to maintain bounded memory usage while preserving relevant execution context.

Margin test results datastore 232 is operable to store structured records generated by margin testing module 216 that characterize tag readability across varying RFID reader operating parameters. The margin test results datastore 232 maintains parameter-associated performance data used to evaluate operating thresholds and to support determination of reader configuration states. More specifically, margin test results datastore 232 stores margin test records that associate tag identifiers, antenna identifiers, parameter values, iteration identifiers, and performance indicators such as read success flags or signal strength measurements. The stored records enable deterministic analysis of test outcomes across multiple test iterations and support reproducible configuration state determination by processing and management module 220. In certain embodiments, margin test records may be versioned or timestamped to preserve historical context across successive testing cycles.

Configuration state datastore 234 is operable to store one or more reader configuration states defining parameter sets applied during tag reading, margin testing, and tuning operations. Each configuration state stored in configuration state datastore 234 may define transmit parameters, receive parameters, debounce criteria, tag filtering thresholds, and antenna-specific assignments used by RFID reader 102. More specifically, configuration state datastore 234 maintains structured configuration entries that associate configuration state identifiers with parameter values and applicability metadata. The processing and management module 220 retrieves configuration state entries from the datastore to apply parameter updates to RF front-end module 212, antenna module 210, and debounce logic module 214. The configuration state datastore 234 may further support versioning, activation flags, or rollback indicators to enable deterministic configuration transitions and controlled evaluation of alternative configuration states.

Reference tag baseline datastore 236 is operable to store baseline values associated with one or more reference tags used by continuous tuning module 218 to detect variation in operating conditions. The reference tag baseline datastore 236 maintains structured baseline records that define expected signal characteristics, read success indicators, or timing metrics associated with reference tags positioned at known locations. More specifically, reference tag baseline datastore 236 stores baseline records indexed by reference tag identifiers and antenna identifiers, enabling continuous tuning module 218 to retrieve baseline values corresponding to specific antenna coverage regions. The stored baseline values are compared against current tag read data during tuning evaluations to detect deviations that trigger configuration state modification. In certain embodiments, baseline records may be updated following margin testing or recalibration to reflect revised nominal operating conditions while preserving historical baseline references. In various embodiments, the datastores may be implemented using volatile memory, non-volatile memory, or combinations thereof, and may be integrated within RFID reader 102 or distributed across local or networked storage resources. The structure and persistence characteristics of the datastores may vary based on deployment requirements while preserving their role in supporting machine-executed debounce processing, margin testing, configuration state determination, and continuous tuning as described herein.

### A. Computer Implemented Process

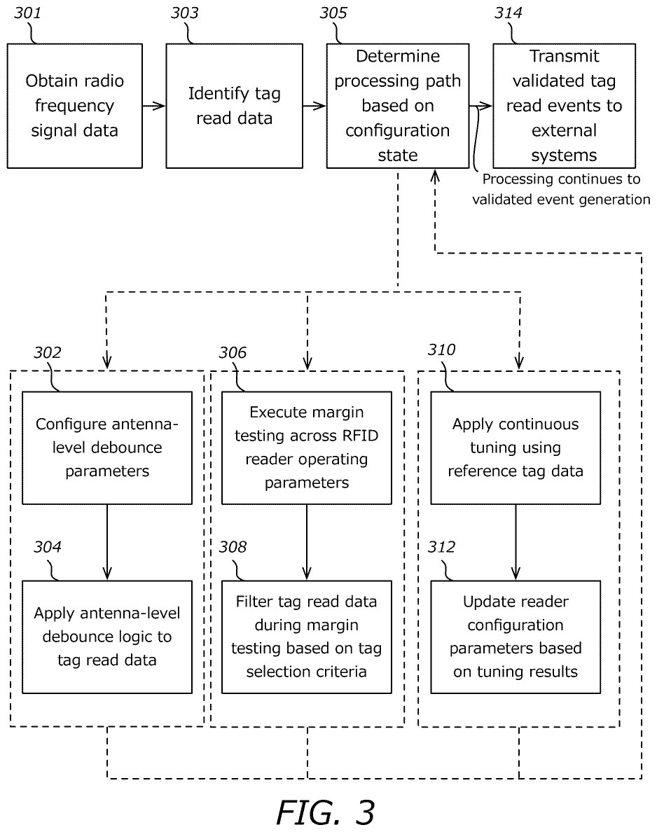

FIG. 3 illustrates an example process executed by an RFID reader system for processing radio frequency signal data and generating validated tag read events. The illustrated process includes multiple processing operations that may be selectively executed, omitted, or combined based on system configuration. Antenna-level debounce processing, margin testing, and continuous tuning are shown as example processing routines that may be executed independently or in combination by the RFID reader system. The process is performed by one or more components of the RFID reader system described with respect to FIGS. 1 and 2, through machine-executable instructions stored in non-transitory memory. The illustrated operations represent one example ordering of system-executed functions, and individual operations may be combined, reordered, or executed conditionally based on configuration parameters, operating conditions, or system state.

In step 301, radio frequency signal data is obtained. The RFID reader system receives radio frequency signal responses generated by one or more RFID tags in response to interrogation signals transmitted via one or more RFID antennas. The obtained radio frequency signal data serves as input for subsequent processing operations executed by the system. In an embodiment, the radio frequency signal data may include, for each detected tag response, signal strength measurements, phase information, timing data, antenna port identifiers, session identifiers, and protocol-level metadata generated during RFID communication exchanges. The signal data may further include repeated tag response instances captured across successive interrogation cycles, antenna coverage regions, or reader configuration states, enabling evaluation of temporal, spatial, and antenna-specific characteristics of tag reads.

In accordance with various embodiments, the RFID reader system obtains the radio frequency signal data from a plurality of RFID antennas that are integrated with, coupled to, or otherwise in communication with the RFID reader system. In certain embodiments, the antennas are physically integrated within a reader housing. In other embodiments, the antennas are externally connected via antenna ports or communicate over wired or wireless interfaces. The system associates received signal data with corresponding antenna identifiers to preserve antenna-level context for subsequent processing. In certain embodiments, the radio frequency signal data is obtained directly by reader-resident RF front-end circuitry that performs signal reception, demodulation, and initial conditioning prior to digital processing. In other embodiments, portions of the signal acquisition or preprocessing are distributed across cooperating reader devices, networked reader systems, or edge-connected components that forward signal data to a processing unit associated with the RFID reader system. In each case, step 301 produces structured radio frequency signal data suitable for machine-executed processing in subsequent steps.

In step 303, tag read data is identified. The RFID reader system processes the obtained radio frequency signal data to detect response signals corresponding to RFID tags and to extract tag identifiers from the detected responses. For each detected tag response, the system generates a tag read record by associating the extracted tag identifier with corresponding read attributes derived from the radio frequency signal data. The associated read attributes may include antenna identifiers, timing information, signal strength measurements, protocol session identifiers, and other signal metadata captured during the interrogation cycle. The resulting tag read records represent structured tag read data suitable for subsequent processing, routing, or evaluation by the RFID reader system.

In step 305, the RFID reader system evaluates processing configuration data to determine which optional processing routines, if any, are to be executed on the identified tag read data prior to generation of validated tag read events. The determination is performed by the RFID reader system using machine-executable configuration logic that independently governs execution of antenna-level debounce processing, margin testing, and continuous tuning.

In an embodiment, the RFID reader system accesses one or more configuration parameters that specify enablement states, execution conditions, or triggering criteria for each optional processing routine. The configuration parameters may be stored in local memory, received from an external system, derived from operating state, or dynamically updated during operation. Each optional processing routine is evaluated independently such that enablement or execution of one routine does not require enablement or execution of any other routine.

When antenna-level debounce processing is enabled, the RFID reader system routes identified tag read data to the debounce processing workflow described with respect to steps 302 and 304 prior to further processing. When margin testing is enabled, the RFID reader system executes the margin testing workflow described with respect to steps 306 and 308 using tag read data generated during controlled interrogation cycles. When continuous tuning is enabled, the RFID reader system executes the tuning workflow described with respect to steps 310 and 312 to evaluate reference tag data and update reader configuration states.

In certain embodiments, two or more optional processing routines are executed sequentially on the same tag read data. In other embodiments, two or more optional processing routines are executed concurrently using separate processing contexts or data paths. In further embodiments, optional processing routines are executed conditionally based on detected operating conditions, elapsed time intervals, completion of prior processing routines, or detected deviations in tag read performance.

In embodiments where none of the optional processing routines are enabled for a given processing context, the RFID reader system bypasses execution of steps 302-312 and forwards the identified tag read data directly toward validated tag read event generation. In all embodiments, completion or bypassing of optional processing routines results in continuation of processing toward generation of validated tag read events, as described with respect to step 314.

In certain embodiments, following identification of tag read data in step 305, the RFID reader system selectively initiates antenna-level debounce processing to evaluate redundancy in the identified tag read data on a per-antenna basis.

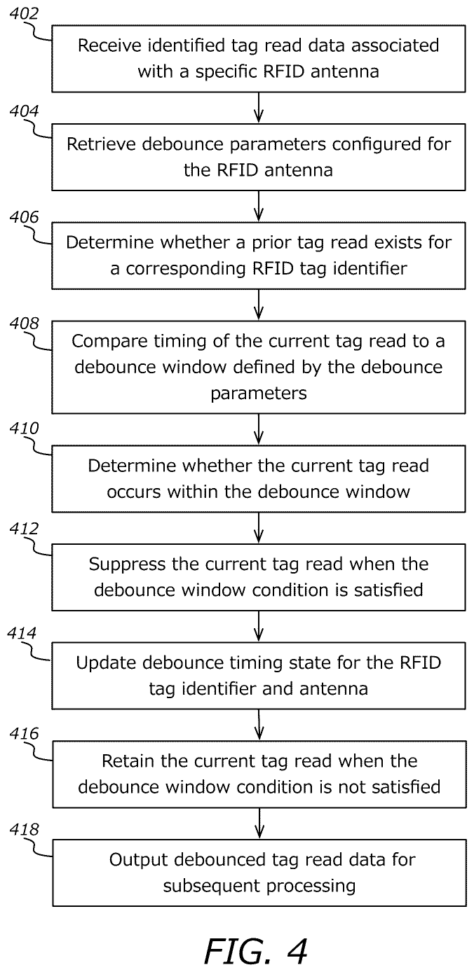

In step 302, antenna-level debounce parameters are configured. The RFID reader system establishes debounce configuration values that define how tag read data associated with individual RFID antennas will be evaluated for redundancy during subsequent processing. The debounce parameters may include antenna-specific debounce window durations, timing thresholds, or filtering criteria used to determine whether repeated tag responses corresponding to the same RFID tag are treated as redundant. The parameters may be applied uniformly across multiple antennas or independently configured on a per-antenna basis, allowing the system to account for differing antenna placements, coverage regions, or operating conditions. The configured debounce parameters are stored and made available to debounce processing logic executed by the RFID reader system. The debounce parameters may be configured independently of execution of margin testing or continuous tuning and may remain active during normal reader operation without requiring execution of any calibration routine. The application of antenna-level debounce logic using the configured parameters is further described with respect to FIG. 4, which illustrates a debounce processing workflow applied to identified tag read data.

In step 304, antenna-level debounce logic is applied to tag read data. The RFID reader system evaluates identified tag read data using the debounce parameters configured for individual RFID antennas to suppress redundant tag reads generated within defined debounce windows. The system compares successive tag read instances associated with the same RFID tag identifier and the same antenna against the configured debounce window for that antenna. When multiple tag read instances occur within the debounce window, the system suppresses one or more redundant instances and retains a single representative tag read record for further processing. Tag read instances that occur outside the debounce window are treated as distinct events and are preserved. The antenna-level debounce logic is executed independently for each RFID antenna, allowing debounce evaluation to occur on a per-antenna basis without cross-interference between antenna coverage regions. This enables the system to maintain antenna-specific read behavior while processing tag read data collected concurrently from a plurality of antennas. In certain embodiments, the debounce logic maintains timing state information, tag presence indicators, or tag-specific counters to track debounce window boundaries and determine when tag read suppression or release conditions are satisfied. The resulting output of step 304 is a filtered set of tag read data in which redundant reads have been suppressed in accordance with antenna-level debounce parameters. The antenna-level debounce workflow executed in step 304 is further described with respect to FIG. 4, which illustrates the sequence of operations performed to evaluate and suppress redundant tag read data on a per-antenna basis.

In certain embodiments, following identification of tag read data in step 305, the RFID reader system selectively initiates margin testing to evaluate tag readability across a range of reader operating parameters.

In step 306, margin testing is executed across a plurality of RFID reader operating parameters. The RFID reader system performs a controlled sequence of configuration adjustments to evaluate tag readability under varying signal conditions using identified tag read data. In certain embodiments, margin testing is executed independently of antenna-level debounce processing and independently of continuous tuning. The system iteratively adjusts one or more operating parameters that govern RFID communication behavior, including transmit power levels, receive sensitivity settings, signal strength thresholds, session or protocol parameters, antenna port selection, dwell time values, and tag filtering criteria. For each configuration state, the system initiates RFID interrogation cycles and collects corresponding tag read data, preserving association between observed tag responses and the configuration parameters under which the responses were generated. Margin testing may be performed by sweeping selected operating parameters across defined ranges using step increments and dwell intervals that allow observation of tag response behavior under progressively varied conditions. The system records tag read performance metrics for each configuration state, including tag detection consistency, response strength, timing stability, and antenna-specific read behavior. In certain embodiments, margin testing is executed autonomously by the RFID reader system without reliance on external testing tools or controllers. Execution may be initiated in response to a predefined schedule, a user-initiated command, detection of an operating anomaly, or a detected change in environmental or operating conditions. Margin testing may be performed using a single antenna or concurrently across multiple antennas, depending on configuration. In some embodiments, the RFID reader system maintains a margin testing context that tracks active test parameters, iteration indices, dwell timing, and tag response aggregation across configuration states. The margin testing context enables correlation of tag read data with specific operating parameter combinations and generation of structured margin testing results for subsequent evaluation.

In step 308, tag read data generated during margin testing is selectively filtered based on one or more tag selection criteria. The RFID reader system evaluates tag read data collected under active margin testing configurations to determine which tag responses are included in margin test analysis. The system applies tag selection criteria that may specify one or more RFID tag identifiers, tag populations, signal attribute thresholds, antenna associations, or protocol-level attributes. The selection criteria may be defined prior to execution of margin testing or dynamically adjusted during testing to focus analysis on a subset of tags relevant to a particular test objective. During margin testing, the system maintains a buffer of tag read data generated across successive configuration states and evaluates buffered tag read data against the tag selection criteria. Tag read instances that satisfy the criteria are selectively retained, while tag read instances that do not satisfy the criteria are excluded. This allows margin testing to be performed in environments containing multiple RFID tags without interference from unrelated tag responses. In certain embodiments, the tag selection criteria are applied on a per-antenna basis, allowing filtering behavior to vary across antenna coverage regions. In other embodiments, the criteria are applied across multiple antennas or configuration states. The filtering operation may be executed in real time as tag read data is generated or as a post-processing operation following completion of one or more margin testing iterations. The filtered tag read data produced in step 308 is used to generate margin testing results that characterize tag readability for the selected tags under evaluated operating parameters and to support determination of reader configuration states and continuous tuning operations.

In certain embodiments, following identification of tag read data in step 305, the RFID reader system selectively initiates continuous tuning to evaluate and adjust reader configuration states based on reference tag data.

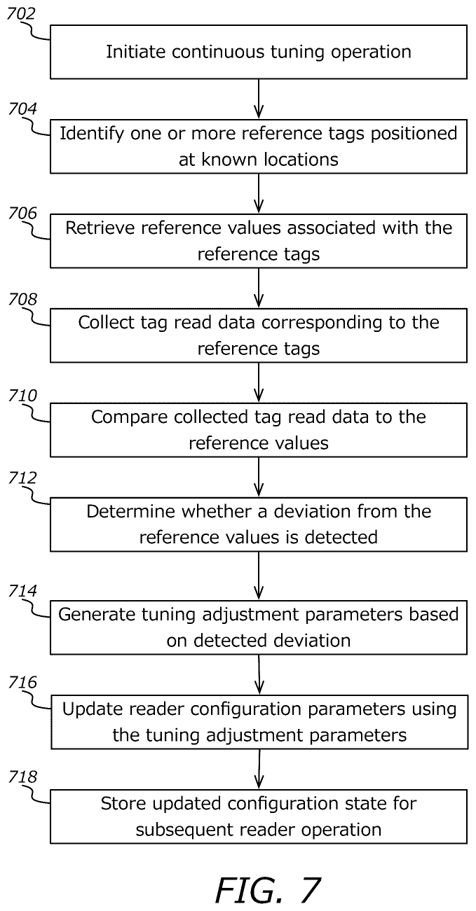

In step 310, continuous tuning is applied using reference tag data. The RFID reader system evaluates tag read data associated with one or more reference tags positioned at known locations to assess variation in reader performance over time and across operating conditions. In certain embodiments, continuous tuning is executed independently of antenna-level debounce processing and independently of margin testing. The system identifies tag read data corresponding to the reference tags and compares observed signal attributes against stored reference values associated with the reference tags. The reference values may represent baseline signal strength measurements, read consistency metrics, timing characteristics, or antenna-specific response profiles established during prior configuration procedures, margin testing, or initialization. Continuous tuning may be performed by periodically executing reference tag evaluation cycles while the RFID reader system operates under normal interrogation conditions. The evaluation cycles may be triggered based on elapsed time intervals, detected deviations from expected tag read behavior, changes in reader configuration states, or completion of other processing routines. The system maintains tuning state information that tracks deviation measurements, historical reference comparisons, and antenna-specific performance trends. Based on detected deviations between current tag read data and corresponding reference values, the RFID reader system determines whether adjustments to reader configuration states are warranted. The continuous tuning logic generates tuning directives that specify candidate parameter modifications for one or more antennas or operating parameters. The continuous tuning workflow executed in step 310 is further described with respect to FIG. 7, which illustrates a reference tag-based tuning process used to evaluate reader performance and generate configuration adjustment directives.

In step 312, reader configuration parameters are updated based on tuning results produced during continuous tuning. The RFID reader system evaluates tuning directives generated during step 310 to determine updated configuration states governing reader operation. The updated configuration parameters may include transmit power levels, receive sensitivity settings, signal strength thresholds, session or protocol parameters, antenna-specific filtering criteria, or combinations thereof. The updates may be applied uniformly across multiple antennas or selectively applied on a per-antenna basis, depending on detected performance variation and tuning results. The RFID reader system updates stored configuration state information to reflect modified parameter values and applies the updated parameters to active reader operation. In certain embodiments, configuration updates are applied immediately following tuning evaluation. In other embodiments, the updates are staged and applied at defined transition points, including between interrogation cycles or during scheduled configuration transitions. In some embodiments, the system records configuration update events, including prior parameter values, updated parameter values, and associated tuning context, to support traceability and subsequent tuning evaluations. The updated configuration parameters may be used during subsequent tag interrogation, debounce processing, margin testing, or continuous tuning operations.

In step 314, validated tag read events are generated and transmitted to one or more external systems. The RFID reader system outputs tag read events derived from identified tag read data processed in accordance with one or more enabled processing routines, including antenna-level debounce processing, margin testing, continuous tuning, or any combination thereof. The validated tag read events include structured tag read records associated with RFID tag identifiers and corresponding metadata, including antenna identifiers, timing information, signal attributes, and configuration context under which the tag reads were generated. The RFID reader system formats the validated tag read events in accordance with one or more communication protocols or data schemas supported by the external systems. The RFID reader system transmits the validated tag read events over one or more communication interfaces to external systems, which may include middleware platforms, enterprise application servers, configuration coordination systems, or other network-connected computing systems. Transmission may occur in real time as validated tag read events are generated or in batches based on buffering, scheduling, or system configuration. In certain embodiments, the RFID reader system applies transmission rules that govern event delivery behavior, including retry logic, acknowledgment handling, event sequencing, or destination-specific filtering. In other embodiments, the validated tag read events are routed to multiple external systems concurrently, allowing the same processed tag data to be consumed by different applications or services. In an embodiment, step 314 represents the convergence point for the processing workflow illustrated in FIG. 3, such that completion or bypassing of any optional processing routines results in continuation toward validated tag read event generation and transmission.

In various embodiments, the RFID reader system executes only a subset of the processing operations illustrated in FIG. 3. Antenna-level debounce processing, margin testing, and continuous tuning may each be enabled or disabled independently based on configuration parameters, system state, or operating conditions. In certain embodiments, antenna-level debounce processing is applied to identified tag read data without performing margin testing or continuous tuning. In other embodiments, margin testing is executed to evaluate reader operating parameters without applying antenna-level debounce logic or continuous tuning. In further embodiments, continuous tuning is applied based on reference tag data independently of margin testing or debounce processing.

In still further embodiments, two or more of antenna-level debounce processing, margin testing, and continuous tuning are executed in combination, sequentially, concurrently, or conditionally. In all embodiments, execution or bypassing of any optional processing routine results in continuation of processing toward generation and transmission of validated tag read events as described with respect to step 314, without requiring that any particular processing operation be dependent on execution of another.

In various embodiments, the operations illustrated in FIG. 3 may include one or more optional processing routines executed by the RFID reader system in addition to, or independent of, other illustrated operations. For example, antenna-level debounce logic may be applied to tag read data to suppress redundant tag reads on a per-antenna basis based on one or more debounce criteria, without performing margin testing or continuous tuning operations.

In other embodiments, the RFID reader system may perform margin testing by executing a sequence of configuration adjustments across multiple RFID reader operating parameters to evaluate tag readability across a range of signal conditions, without applying antenna-level debounce logic or continuous tuning. In such embodiments, the system may determine one or more reader configuration states defining transmit parameters, receive parameters, and tag filtering thresholds for one or more RFID antennas based on the results of the margin testing.

In further embodiments, the RFID reader system may apply continuous tuning by periodically re-evaluating tag read data associated with one or more reference tags and automatically modifying one or more reader configuration states in response to detected variation in operating conditions, without performing margin testing or debounce processing.

In still further embodiments, any combination of antenna-level debounce logic, margin testing, and continuous tuning may be executed sequentially, concurrently, or conditionally based on system configuration, operating state, or deployment requirements. In each case, validated tag read events may be generated based on the applicable processing routines and configuration parameters applied by the RFID reader system.

### B. Computer Implemented Process

FIG. 4 illustrates an example process executed by an RFID reader system for applying antenna-level debounce logic to identified tag read data. The process is performed by one or more components of the RFID reader system described with respect to FIGS. 1 and 2 through machine-executable instructions stored in non-transitory memory. The illustrated operations represent one example sequence for evaluating tag read timing on a per-antenna basis and suppressing redundant tag reads based on configured debounce parameters. The operations shown may be combined, reordered, or executed conditionally based on antenna configuration, debounce criteria, or system state.

In step 402, identified tag read data associated with a specific RFID antenna is received. The RFID reader system obtains structured tag read records generated from prior processing of radio frequency signal data, with each tag read record corresponding to a detected RFID tag response. The tag read data includes a tag identifier and associated metadata extracted from radio frequency signal data, including an antenna identifier indicating the RFID antenna through which the tag response was received. Additional metadata may include timing information, signal strength measurements, protocol session identifiers, or other attributes generated during tag identification processing. The system associates each tag read record with a corresponding RFID antenna based on the antenna identifier. This association preserves antenna-specific context required for subsequent debounce evaluation, enabling antenna-level processing to be applied independently across multiple antennas operating concurrently within the RFID reader system. The received tag read data serves as the input to the antenna-level debounce workflow illustrated in FIG. 4 and is evaluated in subsequent steps using debounce parameters configured for the associated RFID antenna.

In step 404, debounce parameters configured for the RFID antenna associated with the received tag read data are retrieved. The RFID reader system accesses stored debounce configuration information corresponding to the antenna identifier associated with the tag read record. The debounce parameters define antenna-specific criteria used to evaluate whether successive tag read instances are treated as redundant. The parameters may include debounce window durations, timing thresholds, or other antenna-level filtering values established during prior configuration or tuning operations. In certain embodiments, the debounce parameters are stored in a configuration datastore or maintained in memory accessible to debounce processing logic. The system retrieves the debounce parameters using the antenna identifier to ensure that the appropriate debounce configuration is applied to tag read data received from the corresponding antenna. The retrieved debounce parameters are provided to subsequent debounce evaluation steps to enable antenna-level comparison of tag read timing and determination of whether tag read suppression conditions are satisfied.

In step 406, the RFID reader system determines whether a prior tag read exists for a corresponding RFID tag identifier. The system evaluates stored tag read state information to identify whether a previously processed tag read record is associated with the same RFID tag identifier and the same RFID antenna. The system may maintain tag-specific state data that tracks prior tag read occurrences, including timestamps, antenna identifiers, or debounce window status associated with previously retained tag reads. Using the tag identifier extracted from the received tag read data, the system queries the maintained state information to determine whether a prior tag read has been recorded. If no prior tag read is identified for the RFID tag identifier and antenna combination, the system determines that the current tag read represents an initial occurrence for debounce evaluation. If a prior tag read is identified, the system proceeds to compare timing information associated with the current and prior tag reads in subsequent steps to evaluate debounce conditions. The determination performed in step 406 establishes whether temporal comparison logic is required to assess redundancy of the current tag read within the antenna-level debounce workflow.

In step 408, the RFID reader system compares timing information associated with the current tag read to a debounce window defined by the retrieved debounce parameters. The system evaluates the timestamp of the current tag read relative to timing information associated with a prior tag read for the same RFID tag identifier and RFID antenna. The debounce window represents a defined temporal interval during which repeated tag read occurrences are considered candidates for suppression. Using the debounce window duration and timing thresholds specified in the debounce parameters, the system computes whether the elapsed time between the prior tag read and the current tag read falls within the debounce window. The timing comparison may be performed using absolute timestamps, relative time offsets, or counter-based timing values maintained by the system. The comparison is executed on an antenna-specific basis using the debounce parameters retrieved for the corresponding RFID antenna. The result of the timing comparison performed in step 408 is used in subsequent steps to determine whether the current tag read satisfies conditions for suppression or retention within the antenna-level debounce workflow.

In step 410, the RFID reader system determines whether the current tag read occurs within the debounce window defined for the associated RFID antenna. Based on the timing comparison performed in the prior step, the system evaluates whether the elapsed time between the current tag read and a prior tag read for the same RFID tag identifier satisfies the debounce window condition. If the elapsed time falls within the debounce window, the system determines that the current tag read represents a repeated occurrence within the defined debounce interval. If the elapsed time exceeds the debounce window, the system determines that the current tag read represents a distinct occurrence eligible for retention. The determination made in step 410 governs subsequent debounce processing behavior, including whether the current tag read is suppressed or retained. This determination is performed independently for each RFID antenna using antenna-specific debounce parameters and associated timing state information. The result of step 410 is used to control conditional execution of tag read suppression or retention logic in subsequent steps of the antenna-level debounce workflow.

In step 412, the RFID reader system suppresses the current tag read when the debounce window condition is satisfied. When the system determines that the current tag read occurs within the debounce window for the associated RFID antenna, the system prevents the current tag read from being propagated as a retained tag read event. The suppression operation may include discarding the current tag read record, marking the tag read as suppressed, or otherwise excluding the tag read from subsequent processing stages. In certain embodiments, the system maintains suppression state information indicating that the current tag read was evaluated and suppressed based on antenna-level debounce criteria. The suppression of the current tag read is performed on a per-antenna basis using the debounce parameters retrieved for the associated RFID antenna. The suppression operation ensures that repeated tag read occurrences detected within the debounce window do not result in multiple retained tag read events for the same RFID tag. The suppressed tag read is not forwarded for further processing within the RFID reader system, and the debounce workflow proceeds to update debounce timing state information for the corresponding RFID tag identifier and antenna.

In step 414, the RFID reader system updates debounce timing state information associated with the RFID tag identifier and the corresponding RFID antenna. The system records timing information related to the most recent evaluated tag read to maintain antenna-level debounce state across successive tag read occurrences. The debounce timing state may include a timestamp of the most recent retained or evaluated tag read, a debounce window expiration time, or other timing values used to determine whether subsequent tag reads satisfy debounce conditions. The timing state is maintained separately for each RFID tag identifier and each RFID antenna to preserve antenna-specific debounce behavior. In certain embodiments, the updated debounce timing state is stored in memory or a configuration datastore accessible to debounce processing logic. The system updates the timing state regardless of whether the current tag read was suppressed or retained, ensuring that subsequent tag read evaluations are performed using the most recent timing context. The updated debounce timing state is used in subsequent debounce evaluations to determine whether future tag read occurrences fall within or outside the configured debounce window for the associated RFID antenna.

In step 416, the RFID reader system retains the current tag read when the debounce window condition is not satisfied. When the system determines that the elapsed time between the current tag read and a prior tag read exceeds the configured debounce window for the associated RFID antenna, the system treats the current tag read as a distinct occurrence. The retained tag read is preserved as a valid tag read record and is made available for subsequent processing stages. The system associates the retained tag read with the corresponding RFID tag identifier, antenna identifier, and associated metadata, including timing information and signal attributes extracted during prior processing. Retention of the tag read occurs on a per-antenna basis using antenna-specific debounce parameters. The retained tag read reflects a tag response that satisfies debounce criteria and is eligible for use in downstream operations, including margin testing, continuous tuning, and generation of validated tag read events. The retained tag read is forwarded to subsequent processing logic within the RFID reader system following completion of debounce state updates.

In step 418, the RFID reader system outputs debounced tag read data for subsequent processing. The system provides tag read records that have been evaluated using antenna-level debounce logic and determined to be eligible for retention. The output debounced tag read data includes structured tag read records associated with RFID tag identifiers and corresponding metadata, including antenna identifiers, timing information, and signal attributes. Suppressed tag reads are excluded from the output, ensuring that only tag read data satisfying debounce criteria is propagated. The debounced tag read data is forwarded to subsequent processing stages within the RFID reader system, including margin testing, tag filtering during margin testing, continuous tuning, and generation of validated tag read events. The output may be transmitted via internal interfaces, placed in an intermediate buffer, or otherwise made available to processing logic responsible for subsequent workflow execution. The completion of step 418 concludes the antenna-level debounce workflow illustrated in FIG. 4 and provides debounced tag read data for use in later processing steps.

### C. Computer Implemented Process

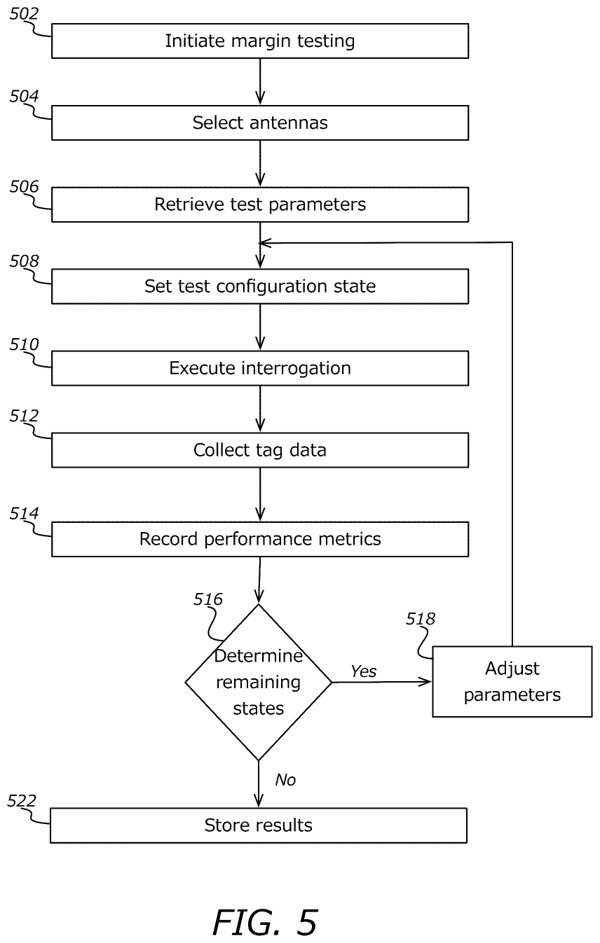

FIG. 5 illustrates an example process executed by an RFID reader system for performing margin testing across a plurality of RFID reader operating parameters. The process is executed by one or more components of the RFID reader system described with respect to FIGS. 1 and 2 through machine-executable instructions stored in non-transitory memory. The illustrated operations represent one example workflow for iteratively applying multiple reader configuration states, executing RFID interrogation cycles, and recording tag read performance metrics associated with each configuration state. The operations shown may be combined, reordered, or conditionally executed based on test configuration parameters, antenna selection, or system state.

In step 502, a margin testing operation is initiated. The RFID reader system transitions into a margin testing mode in which reader operating parameters are systematically varied to evaluate tag readability under multiple configuration states. In accordance with various embodiments, margin testing may be initiated in several ways. In certain embodiments, the margin testing operation is initiated locally by the RFID reader system based on internally stored schedules, operating policies, or detected system conditions. In other embodiments, margin testing is initiated in response to an external command received from a remote system, such as a configuration system, management platform, middleware service, or enterprise application server, communicated over a network connection. Margin testing may also be initiated through an onboard interface associated with the RFID reader system, including local configuration controls or service interfaces. In some embodiments, margin testing is initiated automatically in response to detected operating anomalies, changes in environmental conditions, completion of a prior tuning cycle, or expiration of a defined evaluation interval. In other embodiments, margin testing is initiated as part of a coordinated operation across multiple RFID reader systems operating within a networked deployment, allowing margin testing to be synchronized or distributed across cooperating reader devices. Upon initiation, the RFID reader system establishes an active margin testing context that identifies test scope, selected antennas, and applicable configuration parameters to be evaluated in subsequent steps of the margin testing workflow illustrated in FIG. 5.

In step 504, one or more RFID antennas are selected for participation in the margin testing operation. The RFID reader system identifies the set of antennas for which reader operating parameters will be varied and evaluated during margin testing. The antenna selection may be based on configuration settings associated with the margin testing operation, including explicit antenna identifiers, antenna group definitions, or test scope parameters. In certain embodiments, the system selects all antennas coupled to or in communication with the RFID reader system. In other embodiments, the system selects a subset of antennas based on deployment topology, coverage regions, antenna usage patterns, or prior performance data. In some embodiments, antenna selection is performed independently for each margin testing operation, allowing different antennas to be tested under different parameter sets. In other embodiments, antenna selection is coordinated across multiple reader devices operating within a networked environment, enabling distributed margin testing across cooperating RFID reader systems. The selected antennas are associated with the active margin testing context and are used in subsequent steps to apply test configuration states, execute interrogation cycles, and collect tag read data during margin testing.

In step 506, margin testing configuration parameters are retrieved. The RFID reader system accesses stored test configuration information that defines the operating parameters, ranges, and evaluation settings to be applied during the margin testing operation. The margin testing configuration parameters may include one or more operating parameter ranges to be evaluated, step increment values, dwell time settings, antenna port selections, session or protocol parameters, signal strength thresholds, and optional tag selection criteria. The configuration parameters may further define the order in which configuration states are applied, limits on parameter variation, or conditions under which testing is paused or terminated. In certain embodiments, the margin testing configuration parameters are retrieved from a local configuration datastore maintained by the RFID reader system. In other embodiments, the configuration parameters are obtained from an external system, such as a configuration coordination system, management platform, or enterprise application server, via a network interface. The configuration parameters may also be derived from prior tuning results or updated dynamically based on system state. The retrieved margin testing configuration parameters are associated with the active margin testing context and are used in subsequent steps to generate and apply test configuration states during execution of the margin testing workflow illustrated in FIG. 5.

In step 508, a test configuration state is set. The RFID reader system applies a specific combination of operating parameter values selected from the retrieved margin testing configuration parameters to establish a current test configuration state. The test configuration state defines the active operating conditions under which RFID interrogation is performed during margin testing. The operating parameter values may include transmit power levels, receive sensitivity settings, signal strength thresholds, session or protocol parameters, antenna port selections, dwell time values, tag filtering parameters, or combinations thereof. The parameter values are selected in accordance with the margin testing configuration to represent a distinct point within the operating parameter space to be evaluated. The RFID reader system applies the test configuration state by updating internal configuration registers, control variables, or firmware-managed parameter settings associated with the selected antennas. In certain embodiments, the configuration state is applied on a per-antenna basis, allowing different antennas to operate under different parameter values during margin testing. In other embodiments, the configuration state is applied uniformly across multiple antennas participating in the margin testing operation. The applied test configuration state is recorded in association with the active margin testing context to enable correlation between subsequent tag read data and the specific operating parameters under which the data is generated. The system transitions to executing RFID interrogation cycles using the applied test configuration state in subsequent steps of the margin testing workflow.

In step 510, RFID interrogation is executed using the test configuration state set in the preceding step. The RFID reader system transmits interrogation signals through the selected RFID antennas in accordance with the active operating parameters defined by the current test configuration state. During execution of the interrogation, the RFID reader system generates radio frequency transmissions at the configured transmit power levels and protocol settings and listens for response signals from RFID tags within the coverage regions of the selected antennas. The interrogation may include one or more read cycles, inventory rounds, or protocol-defined exchanges executed over a defined dwell period associated with the test configuration state. The RFID reader system captures tag response data generated during the interrogation, including signal strength measurements, timing information, antenna identifiers, and protocol-level metadata. The interrogation is performed under controlled conditions defined by the test configuration state to enable evaluation of tag readability, response stability, and signal performance across varying operating parameter combinations. In certain embodiments, interrogation execution may be repeated multiple times for a given test configuration state to collect sufficient data for statistical evaluation or consistency checking. In other embodiments, a single interrogation cycle per configuration state may be performed. The resulting tag response data is forwarded to subsequent margin testing steps for filtering, evaluation, and correlation with the applied test configuration state.

In step 512, tag response data generated during execution of the interrogation is collected by the RFID reader system. The system aggregates radio frequency signal data associated with RFID tag responses received from the selected antennas while operating under the active test configuration state. The collected tag data may include, for each detected tag response, tag identifiers, received signal strength indicators, phase or timing measurements, antenna port identifiers, session or inventory round identifiers, and protocol-level metadata produced during the interrogation exchanges. Multiple response instances for a given tag may be captured across successive read cycles, dwell intervals, or antenna coverage regions. The RFID reader system associates the collected tag data with the corresponding test configuration state, including the applied transmit power levels, protocol parameters, antenna selections, and timing settings. This association preserves configuration context for subsequent evaluation of tag readability and performance across differing operating parameter combinations. In certain embodiments, the collected tag data is temporarily buffered in memory or stored in a local datastore for processing during the margin testing sequence. In other embodiments, portions of the tag data may be streamed to cooperating processing components or networked reader systems participating in the margin testing operation. In each case, step 512 produces a structured set of tag response data suitable for filtering, analysis, and comparison in subsequent margin testing steps.

In step 514, performance metrics associated with the collected tag data are recorded by the RFID reader system. The system evaluates the tag response data obtained under the current test configuration state and derives quantitative measures that characterize tag readability and communication performance. The recorded performance metrics may include, for example, successful read counts, missed read occurrences, read consistency across interrogation cycles, signal strength distributions, timing stability, error rates, or protocol-level response characteristics observed during the interrogation. Metrics may be computed on a per-tag basis, a per-antenna basis, or as aggregated measures across multiple tags and antennas participating in the margin testing sequence. The RFID reader system associates the recorded performance metrics with the corresponding test configuration state, including the applied transmit parameters, receive parameters, antenna selections, dwell times, and filtering criteria. This association enables subsequent comparison of performance across different configuration states evaluated during margin testing. In certain embodiments, the performance metrics are stored in a local datastore or memory structure for use in determining reader configuration states and tuning decisions. In other embodiments, the metrics may be transmitted to cooperating reader devices, management systems, or remote processing components for coordinated analysis. In each case, step 514 produces structured performance metric data that reflects tag behavior under controlled operating conditions.

In step 516, the RFID reader system determines whether additional configuration states remain to be evaluated as part of the margin testing sequence. The system evaluates a defined set of test configuration states established by the margin testing parameters and determines whether all combinations of operating parameters have been executed. The determination may include tracking an execution index, counter, state table, or similar control structure representing remaining transmit power levels, receive sensitivity settings, antenna selections, dwell times, tag filtering thresholds, or other configurable parameters included in the margin testing definition. The system compares the current test configuration state against the defined parameter space to identify one or more untested configuration states. When one or more configuration states remain, the system proceeds to apply a next test configuration state and continues margin testing operations at step 508. When no additional configuration states remain, the system concludes the margin testing sequence and transitions to subsequent processing operations, including evaluation of recorded performance metrics and determination of one or more reader configuration states.

In step 518, reader configuration parameters are evaluated and adjusted based on the performance metrics recorded during the margin testing sequence. The RFID reader system analyzes the recorded performance metrics associated with each evaluated test configuration state to identify operating parameter combinations that satisfy one or more performance criteria defined for tag readability, signal stability, or response consistency. The analysis may include comparing performance metrics across configuration states, ranking configuration states based on one or more quantitative measures, or applying threshold-based evaluation logic to determine whether a given configuration state meets predefined acceptability conditions. The adjustment of reader configuration parameters may involve selecting one or more configuration states from the evaluated parameter space to serve as candidate operating states for subsequent reader operation. In certain embodiments, the system selects a single configuration state that exhibits preferred performance characteristics across the selected antennas. In other embodiments, the system selects multiple configuration states, each associated with different antennas, tag populations, or operating contexts. The selected configuration states may define transmit parameters, receive parameters, antenna selections, dwell times, tag filtering thresholds, or combinations thereof. In certain embodiments, the adjustment process includes resolving trade-offs between competing performance metrics, such as read sensitivity versus read stability, or coverage versus noise suppression. The system may apply weighting factors, priority rules, or evaluation policies to balance such considerations when selecting configuration states. The resulting adjusted reader configuration parameters are maintained as candidate operational settings and are used to inform subsequent storage, tuning, or deployment steps executed by the RFID reader system. In certain embodiments, when the adjustment of reader configuration parameters results in one or more additional configuration states to be evaluated, the RFID reader system returns to step 508 and applies a next test configuration state selected from the adjusted parameter set. In other embodiments, when the adjustment yields one or more finalized configuration states and no further evaluation is required, the margin testing loop terminates and the system proceeds to store the resulting performance data and configuration state associations, as described in step 522.

In step 522, performance data and configuration state associations generated during the margin testing sequence are stored by the RFID reader system. The system records, for each evaluated test configuration state, the corresponding performance metrics, parameter values, antenna selections, and evaluation outcomes produced during margin testing. The stored data may include mappings between configuration states and measured tag readability characteristics, signal stability metrics, response consistency indicators, or threshold evaluation results. The performance data and configuration state associations may be stored in one or more local datastores maintained by the RFID reader system, including non-volatile memory structures used to preserve tuning results across power cycles or system restarts. In other embodiments, the data may be transmitted to an external system, such as a configuration coordination system, management platform, middleware service, or enterprise application server, for archival storage, comparative analysis, or coordinated tuning across multiple RFID reader systems. In certain embodiments, the stored performance data is used to support subsequent continuous tuning operations, reader recalibration workflows, or configuration rollback decisions. In other embodiments, the stored data provides a reference history of evaluated parameter states that may be consulted when margin testing is reinitiated or when operating conditions change. In each case, step 522 establishes a persistent record of margin testing outcomes and configuration state relationships that supports ongoing reader configuration management and tuning processes.

### D. Computer Implemented Process

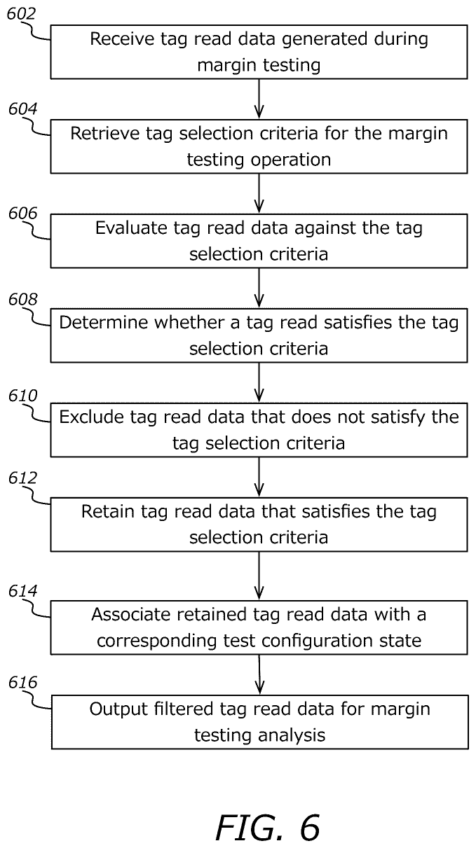

FIG. 6 illustrates an example process executed by an RFID reader system for filtering tag read data generated during margin testing based on one or more tag selection criteria in accordance with various embodiments. The process is performed by one or more components of the RFID reader system described with respect to FIGS. 1 and 2 through machine-executable instructions stored in non-transitory memory. The illustrated operations represent one example workflow for evaluating tag read data produced under a test configuration state, determining whether individual tag reads satisfy defined selection criteria, and retaining or excluding tag read data accordingly for use in margin testing analysis. The operations shown may be combined, reordered, or conditionally executed based on margin testing configuration parameters, tag filtering definitions, or system state.

In step 602, tag read data generated during margin testing is received. The RFID reader system obtains tag read data produced during execution of margin testing operations, including tag response data collected under one or more test configuration states. The received tag read data may include tag identifiers, signal strength measurements, timing information, antenna identifiers, protocol-level metadata, and associations to corresponding configuration states evaluated during margin testing. The system associates the received tag read data with margin testing context information, including the operating parameters under which the data was generated, to preserve configuration-state lineage for subsequent tuning operations.

In step 604, tag selection criteria for the margin testing operation are retrieved. The RFID reader system accesses one or more tag selection definitions that specify which tag read data is to be considered during evaluation of margin testing results. The tag selection criteria may include explicit tag identifiers, identifier ranges, tag classes, memory bank values, encoded data fields, signal strength thresholds, antenna association rules, or combinations thereof. The criteria may further define inclusion or exclusion conditions that govern whether a given tag read instance is eligible for evaluation during margin testing. The tag selection criteria may be retrieved from locally stored configuration data maintained by the RFID reader system, from parameters supplied as part of the margin testing initiation request, or from an external configuration or management system communicating with the reader over a network interface. In certain embodiments, the tag selection criteria are static for the duration of a margin testing sequence. In other embodiments, the criteria may be updated dynamically based on operating context, antenna selection, or intermediate margin testing results. The retrieved tag selection criteria are associated with the active margin testing context and applied in subsequent steps to filter tag read data used for tuning and configuration state determination.

In step 606, the tag read data generated during margin testing is evaluated against the retrieved tag selection criteria. The RFID reader system applies the tag selection criteria to the collected tag read data to determine which tag read instances are eligible for consideration during margin testing analysis. Each tag read instance is examined in relation to the defined inclusion or exclusion conditions, such as matching tag identifiers, encoded data fields, signal strength thresholds, antenna associations, or other criteria specified for the margin testing operation. The evaluation may be performed on a per-tag basis, a per-read-instance basis, or as an aggregated assessment across multiple reads associated with a given tag identifier. In certain embodiments, the system evaluates tag read data in real time as the data is collected during margin testing. In other embodiments, the evaluation is performed on buffered tag read data after completion of one or more interrogation cycles or test configuration states. Tag read instances that satisfy the tag selection criteria are marked for retention and forwarded for subsequent margin testing analysis, while tag read instances that do not satisfy the criteria are excluded from further evaluation. This selective evaluation enables the RFID reader system to focus margin testing analysis on defined tag populations or test targets while reducing interference from unrelated or extraneous tag responses.

In step 608, a determination is made whether a given tag read satisfies the tag selection criteria defined for the margin testing operation. The RFID reader system evaluates each tag read instance against the applicable selection conditions to produce a binary or categorical determination indicating inclusion or exclusion from further margin testing analysis. The determination may involve comparing one or more attributes of the tag read to the tag selection criteria, including tag identifiers, encoded memory values, signal strength measurements, antenna identifiers, read timing information, or protocol-level metadata. In certain embodiments, a tag read satisfies the tag selection criteria when all required conditions are met. In other embodiments, satisfaction may be determined based on partial matches, threshold comparisons, or rule-based evaluation logic defined by the margin testing configuration. When a tag read satisfies the tag selection criteria, the RFID reader system designates the tag read for retention and further processing in subsequent margin testing steps. When the tag read does not satisfy the criteria, the tag read is excluded from further margin testing analysis. This determination step enables controlled inclusion of tag data during margin testing and ensures that subsequent performance evaluation is based on a defined subset of tag reads relevant to the testing objective.

In step 610, tag read data that does not satisfy the tag selection criteria is excluded from further margin testing processing. The RFID reader system suppresses or discards tag read instances that have been determined, in the preceding step, to fall outside the defined selection conditions. The exclusion may involve removing the tag read data from an active evaluation buffer, preventing the tag read from contributing to performance metrics, or marking the tag read as ignored within the margin testing context. In certain embodiments, excluded tag read data is not stored beyond transient processing memory. In other embodiments, excluded tag read data may be logged separately or retained with an exclusion indicator for diagnostic, auditing, or tuning analysis purposes. By excluding tag read data that does not satisfy the tag selection criteria, the RFID reader system constrains margin testing evaluation to a controlled subset of tag reads. This enables subsequent performance analysis to be performed using tag data that is aligned with the defined testing scope and reduces interference from unrelated or extraneous tag responses during margin testing operations.

In step 612, tag read data that satisfies the tag selection criteria is retained for use in subsequent margin testing evaluation and performance analysis. The RFID reader system identifies tag read instances that meet the defined selection conditions and preserves those instances within the active margin testing context. The retained tag read data may be stored in an in-memory buffer, data structure, or datastore that maintains an association between the tag read data, the corresponding test configuration state, and the selected antenna or antenna group. The retained data can include tag identifiers, signal strength measurements, timing information, antenna identifiers, and protocol-level metadata generated during the interrogation cycles. By retaining only tag read data that satisfies the tag selection criteria, the RFID reader system ensures that performance metrics and configuration evaluations are derived from a relevant and controlled subset of tag responses. The retained tag read data is subsequently used to compute performance metrics, compare configuration states, and support tuning and configuration adjustment operations performed in later stages of the margin testing and continuous tuning workflows.

In step 614, retained tag read data is associated with a corresponding test configuration state. The RFID reader system links each retained tag read instance to the specific reader operating parameters under which the tag read was generated during margin testing. The association may include binding the retained tag read data to identifiers representing the active test configuration state, such as transmit power levels, receive sensitivity settings, antenna selections, dwell times, session parameters, or tag filtering thresholds applied during the interrogation cycle. This association preserves configuration context and enables the system to correlate tag read behavior with the operating conditions in effect at the time the tag read was captured. In certain embodiments, the association is maintained through structured records, tables, or indexed data structures that map tag read identifiers to configuration state identifiers within the margin testing context. In other embodiments, the association is embedded directly within the retained tag read data as metadata fields or state references. By associating retained tag read data with the corresponding test configuration state, the RFID reader system enables subsequent evaluation of tag readability and performance across different operating parameter combinations. This association supports later steps involving performance metric computation, configuration state comparison, and determination of reader configuration parameters based on margin testing results.

In step 616, filtered tag read data is output for margin testing analysis. The RFID reader system provides the retained and associated tag read data to one or more processing routines responsible for evaluating tag performance across the tested configuration states. The output may involve transferring the filtered tag read data from an active margin testing buffer to a performance analysis module, a configuration evaluation routine, or a datastore used to compute and store performance metrics. The output data includes tag identifiers, signal measurements, antenna identifiers, timing information, and references to the corresponding test configuration states under which the tag reads were generated. In certain embodiments, the filtered tag read data is output internally within the RFID reader system for local analysis and configuration determination. In other embodiments, the filtered tag read data may be transmitted to cooperating reader devices, management systems, or remote processing components for distributed or coordinated margin testing analysis. In each case, step 616 produces a structured data set suitable for use in evaluating margin testing results and informing subsequent reader configuration and tuning operations.

### E. Computer Implemented Process

FIG. 7 illustrates an example process executed by an RFID reader system for applying continuous tuning using reference tag data in accordance with various embodiments. The process is performed by one or more components of the RFID reader system described with respect to FIGS. 1 and 2 through machine-executable instructions stored in non-transitory memory. The illustrated operations represent one example workflow in which tag read data associated with one or more reference tags positioned at known locations is evaluated to detect operating deviations and to generate tuning adjustments. The operations shown may be performed periodically, conditionally, or in response to detected operating changes, and may be combined, reordered, or executed selectively based on system configuration or deployment context.

In step 702, a continuous tuning operation is initiated. The RFID reader system transitions into a continuous tuning mode in which previously established reader configuration states are evaluated and adjusted over time using reference tag data. The continuous tuning operation may be initiated in several ways. In certain embodiments, continuous tuning is initiated automatically by the RFID reader system based on a predefined schedule, expiration of a tuning interval, or completion of a margin testing sequence. In other embodiments, continuous tuning is initiated in response to detection of operating variation, such as changes in tag read performance, signal stability, or environmental conditions inferred from ongoing tag read data. Continuous tuning may also be initiated by an external command received from a configuration system, management platform, middleware service, or enterprise application server over a network connection. In additional embodiments, initiation may occur through an onboard configuration or service interface associated with the RFID reader system. Upon initiation, the RFID reader system establishes an active continuous tuning context that identifies applicable reference tags, current reader configuration states, evaluation thresholds, and tuning policies to be applied during subsequent tuning steps. The system prepares to analyze tag read data associated with reference tags and to apply controlled adjustments to reader configuration parameters in response to detected variation during the continuous tuning workflow illustrated in FIG. 7.

In step 704, one or more reference tags positioned at known locations are identified. The RFID reader system determines a set of RFID tags that serve as reference points for continuous tuning operations. The reference tags may be predefined as part of system configuration and may be associated with known physical locations, expected signal characteristics, or baseline performance profiles. In certain embodiments, the reference tags are fixed tags installed at known positions within an environment, such as embedded within infrastructure elements, mounted to fixed surfaces, or otherwise positioned to provide consistent reference signals over time. In other embodiments, reference tags may be designated logical reference tags identified by tag identifiers stored in a configuration datastore or received from an external configuration system. The RFID reader system identifies the reference tags by retrieving reference tag identifiers, location metadata, or baseline performance values from local memory or from an external system over a network connection. The identified reference tags are associated with the active continuous tuning context and are used in subsequent steps to evaluate tag read data and detect variation in reader operating conditions during the continuous tuning workflow.

In step 706, reference values associated with the reference tags are retrieved. The RFID reader system accesses stored baseline information corresponding to the identified reference tags to establish expected performance characteristics for use during continuous tuning. The reference values may include one or more baseline measurements associated with each reference tag, such as expected received signal strength ranges, timing characteristics, read frequency, antenna association data, or protocol-level response attributes. In certain embodiments, the reference values further include configuration-state-specific expectations derived from prior margin testing results, commissioning procedures, or historical tuning operations. The RFID reader system retrieves the reference values from a local datastore maintained by the reader, from memory associated with the processing and management module, or from an external system such as a configuration coordination system or management platform accessed over a network connection. The retrieved reference values are associated with the corresponding reference tag identifiers and are used in subsequent steps to compare against current tag read data to detect variation in operating conditions during continuous tuning.

In step 708, tag read data corresponding to the reference tags is collected. The RFID reader system executes one or more interrogation cycles using the current reader configuration parameters and captures tag read data generated by the identified reference tags positioned at known locations. The collected tag read data may include, for each reference tag response, tag identifiers, received signal strength indicators, timing measurements, antenna identifiers, session or inventory round information, and protocol-level metadata generated during RFID communication exchanges. Multiple response instances for a given reference tag may be collected across successive read cycles or dwell intervals to capture temporal behavior and signal variability. The RFID reader system associates the collected tag read data with the corresponding reference tag identifiers and the current reader configuration state. This association preserves contextual information necessary for subsequent comparison against stored reference values and supports detection of deviations in reader performance or operating conditions during the continuous tuning process.

In step 710, the collected tag read data is compared to the reference values associated with the reference tags. The RFID reader system evaluates the tag read data obtained for each reference tag against stored reference values that define expected signal characteristics under nominal operating conditions. The comparison may include evaluating differences between measured signal strength values and reference signal strength ranges, assessing timing or phase deviations relative to expected response characteristics, or comparing read consistency metrics against predefined reference thresholds. The system may perform the comparison on a per-antenna basis, a per-reference-tag basis, or as aggregated measures across multiple reference tags and interrogation cycles. The RFID reader system determines the magnitude and direction of any deviations between the collected tag read data and the corresponding reference values. The results of the comparison are used to identify changes in reader performance, environmental conditions, or antenna behavior that may warrant modification of reader configuration parameters during subsequent continuous tuning steps.

In step 712, a determination is made as to whether a deviation from the reference values is detected. The RFID reader system evaluates the results of the comparison between the collected tag read data and the corresponding reference values to identify whether one or more deviation conditions are present. The determination may involve applying threshold-based evaluation logic, tolerance ranges, or statistical comparison criteria to assess whether observed differences in signal strength, timing characteristics, read consistency, or other measured attributes exceed acceptable bounds defined for nominal operation. The evaluation may be performed individually for each reference tag, for each antenna associated with the reference tags, or across aggregated measurements collected during the continuous tuning cycle. When the evaluated differences fall within acceptable limits, the system determines that no deviation is detected and maintains the current reader configuration state. When one or more evaluated differences exceed defined thresholds or tolerance ranges, the system determines that a deviation from the reference values is detected and proceeds to modify reader configuration parameters in subsequent continuous tuning steps.

In step 714, tuning adjustment parameters are generated based on the detected deviation. When a deviation from the reference values is identified, the RFID reader system computes one or more adjustment parameters that define how the reader configuration should be modified to compensate for the detected variation. The generation of tuning adjustment parameters may include determining adjustments to transmit power levels, receive sensitivity settings, antenna-specific parameters, signal strength thresholds, dwell times, session parameters, or tag filtering criteria. The adjustment parameters may be computed on a per-antenna basis, a per-reference-tag basis, or using aggregated deviation metrics derived across multiple reference tags and interrogation cycles. In certain embodiments, the system applies deterministic adjustment logic that maps specific deviation magnitudes or patterns to corresponding parameter changes. In other embodiments, the system applies rule-based evaluation, lookup tables, or weighted decision logic to derive tuning adjustments that address observed deviations while maintaining compliance with defined operating constraints. The generated tuning adjustment parameters are associated with the current reader configuration state and are used in subsequent steps to update reader configuration settings during the continuous tuning operation.

In step 716, reader configuration parameters are updated using the tuning adjustment parameters. The RFID reader system applies the generated tuning adjustment parameters to modify one or more configuration settings governing reader operation. The update may include adjusting transmit power levels, receive sensitivity values, antenna-specific operating parameters, signal strength thresholds, dwell times, session parameters, or tag filtering criteria associated with the RFID reader system. The updates may be applied uniformly across multiple antennas or selectively applied on a per-antenna basis, depending on the scope of the detected deviation and the tuning adjustment parameters generated in the preceding step. The RFID reader system updates internal configuration registers, control variables, or firmware-managed parameter settings to effect the modified reader configuration state. The updated configuration parameters are associated with the continuous tuning context and are used in subsequent interrogation and monitoring operations to evaluate whether the applied adjustments restore tag read behavior to within acceptable reference ranges.

In step 718, the updated configuration state is stored for subsequent reader operation. The RFID reader system persists the modified configuration parameters resulting from the continuous tuning operation in a configuration datastore or equivalent memory structure. The stored configuration state may include transmit parameters, receive parameters, antenna-specific settings, signal strength thresholds, dwell times, session parameters, and tag filtering criteria that define the updated operating conditions for the RFID reader system. The configuration state may be stored with associated metadata identifying the tuning cycle, reference tags used, evaluation timestamps, or operating context under which the configuration was derived. In certain embodiments, the stored configuration state is designated as an active operational configuration to be applied during subsequent RFID interrogation and tag processing operations. In other embodiments, the stored configuration state is maintained as a candidate or fallback configuration that may be selectively activated based on future tuning cycles, operating conditions, or management system directives.

### Hardware Architecture

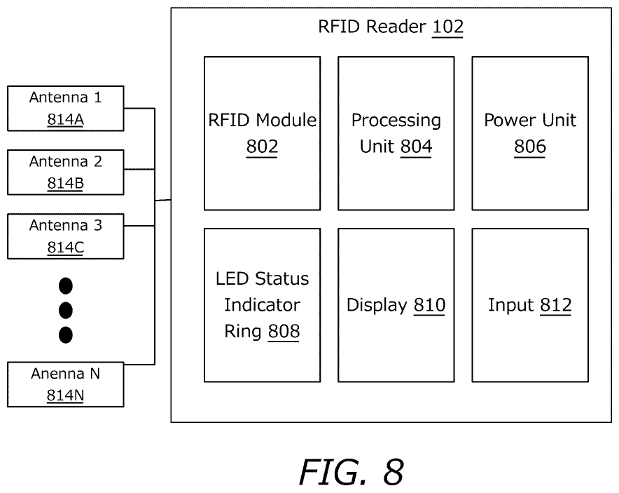

FIG. 8 illustrates an exemplary embodiment of a Radio Frequency Identification (RFID) reader device in accordance with the present disclosure. The RFID reader device comprises a housing that encloses a processing unit, an RFID module, and supporting interfaces for antenna connectivity, network communication, status indication, and user interaction. The illustrated components define one example physical and logical arrangement for executing machine-implemented RFID interrogation, tag read processing, debounce evaluation, margin testing, and continuous tuning operations as described herein. The components depicted are exemplary and may be reorganized, combined, or distributed across multiple hardware assemblies without departing from the scope of the disclosure.

As shown, the RFID reader device includes a processing unit 804 operable to execute machine-readable instructions that coordinate operation of the RFID module 802, antenna ports (814A, 814B, 814C, and 814N), LED status indicator ring 808, display 810, and input 812 controls. The RFID reader device further includes an RFID module operatively coupled to the processing unit and configured to generate and receive radio frequency signals for communicating with RFID tags via a plurality of antenna ports disposed on the housing. The device further includes a status indicator disposed on the housing and operatively coupled to the processing unit, the status indicator being operable to indicate a status of the RFID reader device, including a status associated with margin testing or continuous tuning. A user interface disposed on the housing provides local access to configuration and status information under control of the processing unit.

RFID module 802 is operable to generate and receive radio frequency signals for communicating with RFID tags. The RFID module 802 executes RFID protocol exchanges under control of the processing unit and produces tag response data used by the system to identify tag read events and associated signal characteristics. More specifically, RFID module 802 applies transmit parameters, receive parameters, session settings, and protocol timing values defined by the processing unit to execute RFID interrogation cycles. The RFID module outputs radio frequency signal data including tag identifiers, received signal strength indicators, antenna port identifiers, timing information, and protocol-level metadata used in subsequent debounce processing, margin testing, and tuning operations.

Processing unit 804 is disposed within the housing and is operable to execute machine-readable instructions that control operation of the RFID reader device. The processing unit coordinates operation of the RFID module 802, antenna ports, status indicator, display, and user input controls. The processing unit 804 maintains configuration state information governing reader operation, including debounce parameters, margin testing parameters, and tuning configuration states. The processing unit further executes logic for applying antenna-level debounce evaluation, initiating and managing margin testing workflows, applying tuning adjustments, and generating validated tag read events for transmission to external systems.

Power unit 806 is operable to provide regulated electrical power to processing unit 804, RFID module 802, and associated peripheral components. In certain embodiments, power unit 806 supports delivery of power via an external power source or via a network interface that provides both power and data connectivity. The power unit 806 may include voltage regulation circuitry, power monitoring logic, and protection mechanisms that support continuous operation of the RFID reader under varying load conditions during interrogation, margin testing, and tuning cycles.

LED status indicator ring 808 is operable to present machine-controlled visual status indications corresponding to operational states of RFID reader 102. The indicator ring is coupled to processing unit 804 and is controlled based on internal system state, including margin testing activity, tuning activity, error conditions, or connectivity status. More specifically, processing unit 804 drives LED status indicator ring 808 using color values, illumination patterns, and timing sequences that reflect reader operating states. The indicator ring may be controlled independently of user input and may reflect autonomous system activity occurring during testing or tuning operations.

Display 810 is operable to present system status information, configuration menus, and operational indicators generated by processing unit 804. Input controls 812 are operable to receive user input for navigating menus, selecting configuration options, or initiating system functions. In certain embodiments, display 810 comprises an OLED display, and input controls 812 comprise a set of discrete input buttons. In other embodiments, display 810 and input controls 812 may be combined into an integrated touchscreen interface. Processing unit 804 interprets input signals received from input controls 812 and updates display output accordingly.

A plurality of antenna ports 814A-814N are disposed on the housing and are operatively coupled to RFID module 802. Each antenna port is configured to connect to an RFID antenna for transmitting and receiving radio frequency signals. The antenna ports preserve antenna-specific context that enables per-antenna configuration, debounce evaluation, margin testing, and tuning. Antenna-specific identifiers associated with the antenna ports are used by the processing unit to associate tag read data with corresponding antennas during system operation.

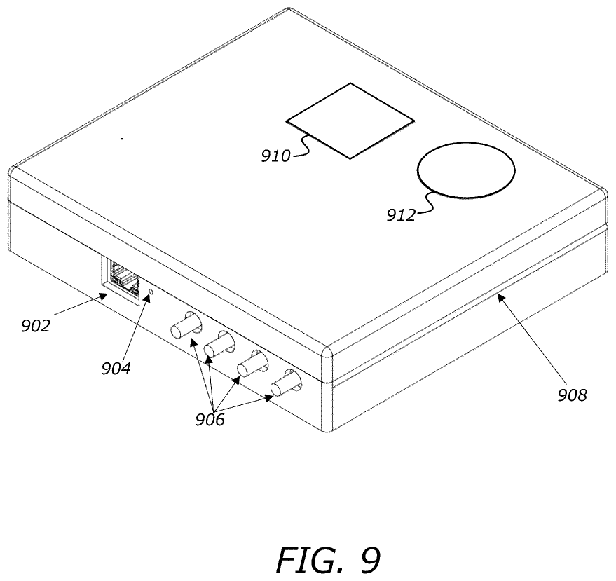

FIG. 9 illustrates an exemplary physical embodiment of RFID reader 102, including device-level interfaces and status indication components that support execution, configuration, and monitoring of RFID reader operations. As shown, RFID reader 102 includes ethernet interface 902, reset input 904, antenna ports 906, LED status ring 908, display 910, and user input buttons 912. The illustrated components are exemplary and may be reorganized, combined, or implemented using alternative physical arrangements without departing from the scope of the disclosure.

The processing unit and RFID module housed within RFID reader 102 execute machine-readable instructions that implement the internal functional components described with respect to FIG. 2, including antenna-level debounce logic, margin testing workflows, continuous tuning operations, and processing and management functions. Ethernet interface 902 provides a physical communication interface through which the RFID reader system exchanges data and control messages with external systems, configuration services, or management platforms. In certain embodiments, ethernet interface 902 supports power delivery and data communication over a single physical connection. Antenna ports 906 provide physical coupling points for one or more external RFID antennas, enabling radio frequency signal transmission and reception associated with tag interrogation and response acquisition.

LED status ring 908 is disposed around a perimeter region of RFID reader 102 and is operable to generate visual output patterns representing operational states of the RFID reader system. The LED status ring 908 is controlled by the processing unit based on system-executed evaluation of internal state, configuration context, and processing activity. In various embodiments, the LED status ring 908 is operable to display distinct illumination states corresponding to reader operation modes, network connectivity states, fault conditions, debounce or margin testing activity, tuning operations, or other machine-determined system conditions. Illumination states may include static color output, pulsed output, rotating patterns, or multi-color sequences generated in accordance with control signals produced by the processing and management module of FIG. 2. The LED status ring 908 is visible circumferentially around the device housing, enabling status indication to be perceived without requiring a specific viewing orientation.

In certain embodiments, the LED status ring 908 is updated dynamically during execution of margin testing or continuous tuning workflows to reflect active evaluation states, progression through test configuration states, or completion of tuning operations. For example, the LED status ring 908 may present a first illumination pattern when the RFID reader system enters a margin testing mode, a second illumination pattern during iterative evaluation of operating parameter states, and a third illumination pattern upon completion or suspension of testing. The illumination behavior of LED status ring 908 may be driven by machine-generated state indicators, counters, or evaluation results produced during execution of the processes described with respect to FIGS. 3-7.

Display 910 is integrated into a surface of RFID reader 102 and is operable to present machine-generated output data associated with system configuration, operational state, or diagnostic evaluation. Displayed information may include network configuration parameters, antenna status information, reader operating mode indicators, test execution status, or error conditions determined by the processing unit. In certain embodiments, display 910 operates in conjunction with user input buttons 912 to provide a local interface for navigating configuration menus, initiating system operations, or reviewing system state without requiring an external computing device.

User input buttons 912 provide physical input mechanisms through which configuration commands, navigation inputs, or control selections are received by the RFID reader system. Button inputs are processed by the processing unit and mapped to corresponding configuration updates, system commands, or interface navigation operations. In certain embodiments, the combination of display 910 and user input buttons 912 enables local initiation of margin testing operations, adjustment of debounce parameters, review of antenna status, or execution of diagnostic routines. Reset input 904 provides a physical mechanism for initiating a system reset or recovery operation, which may include restarting firmware execution, clearing volatile state, or restoring stored configuration parameters, depending on implementation.

The components illustrated in FIG. 9 provide a physical execution and interaction layer through which the internal functional modules of FIG. 2 are realized and controlled. The LED status ring 908, display 910, and user input buttons 912 collectively expose machine-executed system state and configuration transitions in a device-resident form, while ethernet interface 902 and antenna ports 906 support external communication and radio frequency signal exchange required for execution of RFID reader operations.

In accordance with various embodiments, the hardware components and interfaces illustrated in FIGS. 8 and 9 provide the execution environment through which the internal functional components of the RFID reader system illustrated in FIG. 2 operate. The processing unit, RFID module, antenna ports, network interface, status indicator, display, and user input controls collectively support execution of machine-readable instructions that implement the antenna-level debounce logic, margin testing operations, continuous tuning workflows, and management functions described with respect to FIG. 2. More specifically, the antenna ports and RFID module illustrated in FIGS. 8 and 9 provide the radio frequency signal acquisition path used by the antenna module, RF front-end module, debounce logic module, margin testing module, and continuous tuning module of FIG. 2. The processing unit executes the processing and management functions of FIG. 2 by coordinating configuration state, parameter updates, and data flow between these internal modules. The external system interface, configuration interface, and status and indicator interface described with respect to FIG. 2 are physically realized through the network interface, display, status indicator, and user input components illustrated in FIGS. 8 and 9, enabling both local and remote interaction with the RFID reader system during operation.

The various hardware aspects improve user experience, increase efficiency, and enable users to provide improved maintenance and support. The various components reduce the need for external tools or software, saving time and resources. Users can quickly make adjustments to settings, perform troubleshooting, and optimize performance without relying on specialized equipment or personnel. The ability to access and configure the reader's advanced firmware features, such as antenna-level debounce control, on-device margin testing, and continuous tuning, directly through the intuitive menu system allows users to adapt the reader's performance to specific environmental conditions or operational requirements in real-time.

Generally, the techniques disclosed herein may be implemented on hardware or a combination of firmware, software and/or hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

Any of the systems, modules, interfaces, processing units, controllers, components, or process operations described herein may be implemented using hardware, software, firmware, or any combination thereof, as described throughout this specification. In various embodiments, the functionality attributed to the RFID reader system and its internal components may be executed by reader-resident processing circuitry, cooperating edge devices, or network-connected computing systems operating in coordination with the RFID reader system. The modules, interfaces, and processing components described with respect to FIG. 1-7 may include executable logic stored in non-transitory memory and executed by one or more processors to perform radio frequency signal acquisition, antenna-level debounce processing, margin testing, continuous tuning, configuration evaluation, and transmission of validated tag read events. In certain embodiments, portions of the disclosed functionality are implemented within firmware or hardware logic integrated with the RFID reader system. In other embodiments, portions of the functionality are implemented using software modules executing on general-purpose or special-purpose processors associated with the RFID reader system or external computing resources. In various embodiments, one or more of the systems, modules, interfaces, or components described herein may communicate with other systems or components using defined communication interfaces, including application programming interfaces. Such interfaces may be used to exchange configuration parameters, reader status information, performance metrics, tag read data, or control instructions between the RFID reader system and external systems, including configuration coordination systems, middleware platforms, enterprise application servers, or management services. The communication may occur over wired or wireless communication links and may utilize one or more standardized or proprietary communication protocols, depending on deployment context and system configuration.

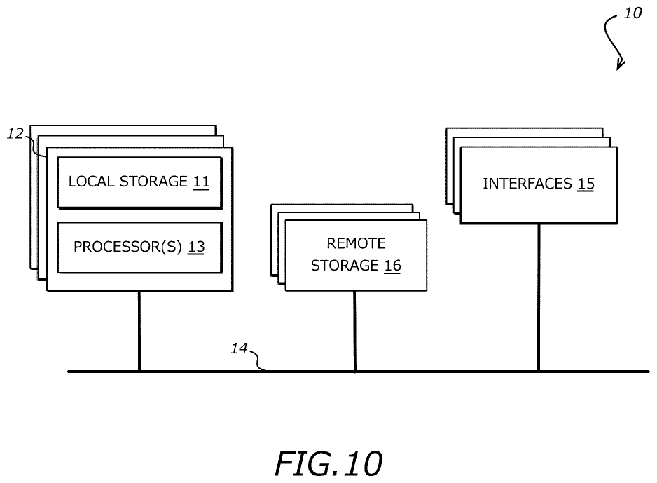

Referring now to FIG. 10, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software-or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 10 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

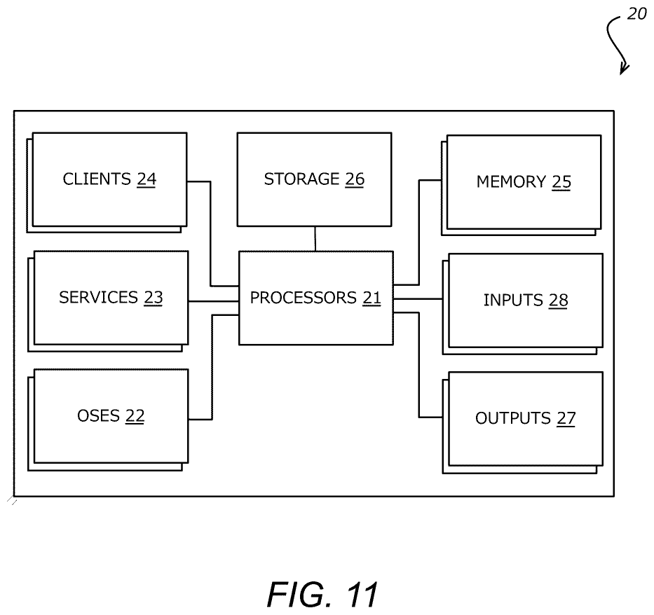

In some embodiments, systems may be implemented on a standalone computing system. Referring now to FIG. 11, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 10). Examples of storage devices 26 include flash memory, magnetic hard drive, CD-ROM, and/or the like.

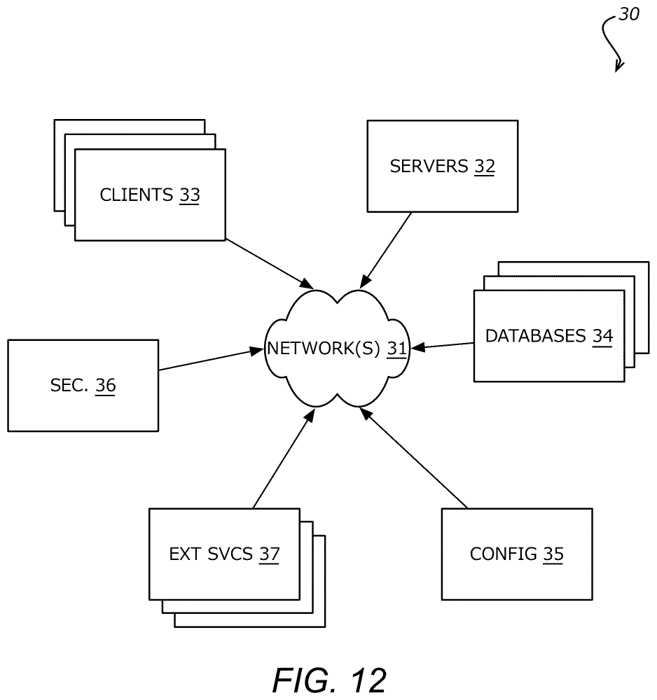

In some embodiments, systems may be implemented on a distributed computing network, such as one having any number of clients and/or servers. Referring now to FIG. 12, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 11. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

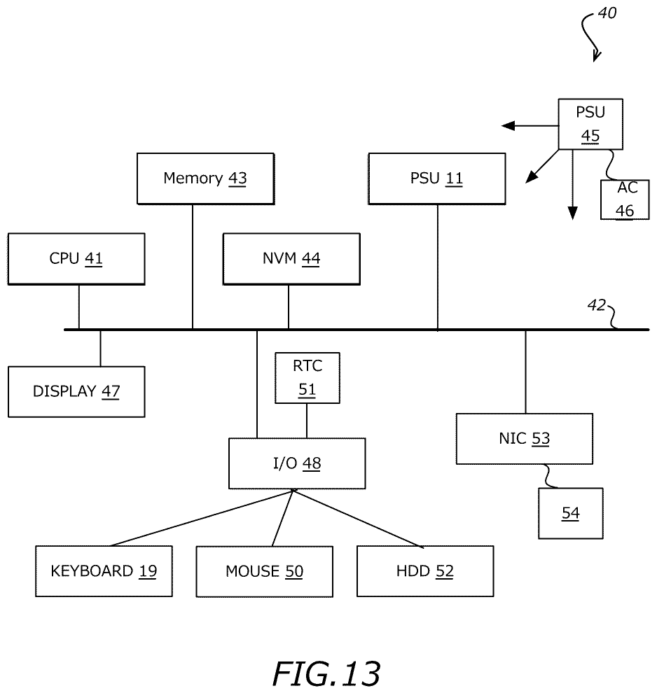

FIG. 13 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present) , and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A Radio Frequency Identification (RFID) reader system, comprising:
a processor; and
a memory storing instructions that, when executed by the processor, cause the RFID reader system to:
obtain radio frequency signal data from a plurality of RFID antennas operatively coupled to the RFID reader system;
process the radio frequency signal data to identify tag read data corresponding to RFID tags detected within respective antenna coverage regions; and
generate validated tag read events based on configurable processing of the tag read data.

2. The RFID reader system of claim 1, wherein a configurable processing comprises applying antenna-level debounce logic to the tag read data, the antenna-level debounce logic being configured to suppress redundant tag reads on a per-antenna basis based on one or more debounce criteria.

3. The RFID reader system of claim 2, wherein the debounce window is independently configurable for each RFID antenna based on operating conditions.

4. The RFID reader system of claim 1, wherein the configurable processing comprises performing margin testing by executing a sequence of configuration adjustments across a plurality of RFID reader operating parameters to evaluate tag readability across a range of signal conditions.

5. The RFID reader system of claim 4, wherein the plurality of RFID reader operating parameters includes at least two of transmit power, receive sensitivity, signal strength thresholds, session parameters, or tag filtering parameters.

6. The RFID reader system of claim 4, wherein determining one or more reader configuration states comprises:
analyzing tag read performance results produced during margin testing;
selecting transmit parameters based on the tag read performance results;
selecting receive parameters based on the tag read performance results; and
selecting tag filtering thresholds based on the tag read performance results.

7. The RFID reader system of claim 6, wherein the one or more reader configuration states are determined separately for individual RFID antennas.

8. The RFID reader system of claim 4, wherein performing margin testing comprises triggering the margin testing in response to at least one of a user-initiated command, a predefined schedule, or detection of an operating anomaly.

9. The RFID reader system of claim 4, wherein performing margin testing further comprises maintaining a buffer of tag read data generated during a margin testing interval and selectively evaluating a subset of the tag read data based on one or more tag filtering criteria.

10. The RFID reader system of claim 4, wherein the plurality of RFID reader operating parameters include at least two of an antenna port selection, a signal strength range, a step increment value, a dwell time, or a tag filtering parameter.

11. The RFID reader system of claim 1, wherein the configurable processing comprises applying continuous tuning by re-evaluating tag read data associated with one or more reference tags and automatically modifying one or more reader configuration states in response to detected variation in operating conditions.

12. The RFID reader system of claim 11, wherein the continuous tuning is performed at periodic intervals or in response to detected changes in operating conditions.

13. The RFID reader system of claim 1, wherein the configurable processing comprises both applying antenna-level debounce logic and performing margin testing.

14. The RFID reader system of claim 1, wherein the configurable processing comprises both performing margin testing and applying continuous tuning.

15. The RFID reader system of claim 1, wherein the configurable processing comprises applying antenna-level debounce logic, performing margin testing, and applying continuous tuning.

16. A Radio Frequency Identification (RFID) reader device, comprising:
a housing;
a processing unit disposed within the housing;
an RFID module disposed within the housing and operatively coupled to the processing unit, the RFID module configured to generate and receive radio frequency signals for communicating with RFID tags;
a plurality of antenna ports disposed on the housing and operatively coupled to the RFID module, each antenna port being configured to connect to an RFID antenna;
a status indicator disposed on the housing and operatively coupled to the processing unit, the status indicator being operable to indicate a status of the RFID reader device, including a status associated with margin testing or continuous tuning; and
a user interface disposed on the housing and operatively coupled to the processing unit.

17. The RFID reader device of claim 16, wherein the status indicator comprises an LED status ring disposed on an exterior surface of the housing.

18. The RFID reader device of claim 17, wherein the LED status ring is configured to display one of different colors corresponding to different statuses of the RFID reader device or different illumination patterns corresponding to different statuses of the RFID reader device.

19. The RFID reader device of claim 16, wherein the user interface comprises a display configured to present at least one of device status information, network configuration options, or testing functions, and wherein the user interface further comprises one or more user input controls configured to navigate menus, select options, or initiate functions of the RFID reader device.

20. A non-transitory computer-readable medium storing instructions that, when executed by one or more processors of a Radio Frequency Identification (RFID) reader system, cause the RFID reader system to:
obtain radio frequency signal data from a plurality of RFID antennas operatively coupled to the RFID reader system;
process the radio frequency signal data to identify tag read data corresponding to RFID tags detected within respective antenna coverage regions;
apply antenna-level debounce logic to the tag read data, the antenna-level debounce logic being configured to suppress redundant tag reads on a per-antenna basis based on one or more debounce criteria;
perform margin testing by executing a sequence of configuration adjustments across multiple RFID reader operating parameters to evaluate tag readability across a range of signal conditions;
determine, based on results of the margin testing, one or more reader configuration states defining transmit parameters, receive parameters, and tag filtering thresholds for the plurality of RFID antennas;
apply continuous tuning by periodically re-evaluating tag read data using reference tags and automatically modifying the one or more reader configuration states in response to detected variation in operating conditions;
recalibrate the RFID reader system by updating configuration parameters applied to the plurality of RFID antennas based on the continuous tuning; and
generate validated tag read events using recalibrated configuration parameters.
